(19) United States
(12) Patent Application Publication
(10) Pub. No.: US 2025/0364711 A1
(43) Pub. Date: Nov. 27, 2025

(54) PHASE SHIFTER AND ANTENNA DEVICE

(71) Applicant: NEC Corporation, Minato-ku, Tokyo (JP)

(72) Inventors: Kohei YOSHIDA, Tokyo (JP); Kenji WAKAFUJI, Tokyo (JP); Ryota NIHEI, Tokyo (JP); Kazuyuki HAYASHI, Tokyo (JP); Fujio OKUMURA, Kanagawa (JP)

(73) Assignee: NEC Corporation, Minato-ku, Tokyo (JP)

(21) Appl. No.: 18/872,349

(22) PCT Filed: Aug. 8, 2022
(86) PCT No.: PCT/JP2022/030316

§ 371 Date: Dec. 6, 2024

(51) Int. Cl. H01P 1/18; H01Q 9/04

(52) U.S. Cl. CPC H01P 1/184; H01Q 9/0407

(57) ABSTRACT

A phase shifter that includes a hub portion that is connected to a power-feeding point of a patch antenna, a switch group that includes a plurality of switches, a spoke portion that is disposed radially centered on the hub portion and includes a plurality of radial lines that is electrically connected to the hub portion via any of the plurality of switches, and a rim portion that is disposed along an arc centered on the hub portion and includes a plurality of arcuate lines that is electrically connected to the plurality of radial lines via any of the plurality of switches.

### TECHNICAL FIELD

The present disclosure relates to a phase shifter and the like mounted on an antenna device.

### BACKGROUND ART

For mobile communication after the fifth-generation mobile communication, an antenna device compatible with radio waves in a high frequency band has been developed. In such an antenna device, a phase shifter is mounted on a preceding stage of the antenna element. A beam having a desired directivity can be formed by changing the excitation phase of the antenna element using the phase shifter. For example, when a switched line phase shifter is used, a phase shift range up to 360 degrees can be covered, so that a large scanning angle can be achieved. However, it has been difficult to incorporate such a phase shifter in a small antenna device such as a patch antenna.

PTL 1 discloses a microstrip antenna capable of changing a phase. The microstrip antenna of PTL 1 has a function of changing a phase of a circularly polarized wave and a function of transmitting the circularly polarized wave.

### CITATION LIST

### Patent Literature

PTL 1: JP 2020-072383 A

### SUMMARY OF INVENTION

### Technical Problem

By using a plurality of the microstrip antennas of PTL 1, an array antenna capable of controlling directivity can be configured. The microstrip antenna of PTL 1 can be used for transmitting and receiving circularly polarized waves. However, the microstrip antenna of PTL 1 cannot be used for transmission and reception of linearly polarized waves.

An object of the present disclosure is to provide a phase shifter or the like applicable to a patch antenna having a size related to a wavelength of a signal to be transmitted/received regardless of a polarization state of a radio wave to be transmitted/received.

### Solution to Problem

A phase shifter according to an aspect of the present disclosure includes a hub portion that is connected to a power-feeding point of a patch antenna, a switch group that includes a plurality of switches, a spoke portion that is disposed radially centered on the hub portion and includes a plurality of radial lines that is electrically connected to the hub portion via any of the plurality of switches, and a rim portion that is disposed along an arc centered on the hub portion and includes a plurality of arcuate lines that is electrically connected to the plurality of radial lines via any of the plurality of switches.

### Advantageous Effects of Invention

According to the present disclosure, it is possible to provide a phase shifter or the like applicable to a patch antenna having a size related to a wavelength of a signal to be transmitted/received regardless of a polarization state of a radio wave to be transmitted/received.

### BRIEF DESCRIPTION OF DRAWINGS

FIG. 1 is a conceptual diagram illustrating an example of a configuration of a phase shifter according to a first example embodiment.

FIG. 2 is a conceptual diagram illustrating a phase shift control example using the phase shifter according to the first example embodiment.

FIG. 3 is a conceptual diagram illustrating a phase shift control example using the phase shifter according to the first example embodiment.

FIG. 4 is a conceptual diagram illustrating a phase shift control example using the phase shifter according to the first example embodiment.

FIG. 5 is a conceptual diagram illustrating an example of a configuration of a phase shifter according to a second example embodiment.

FIG. 6 is a conceptual diagram illustrating a phase shift control example using the phase shifter according to the second example embodiment.

FIG. 7 is a conceptual diagram illustrating a phase shift control example using the phase shifter according to the second example embodiment.

FIG. 8 is a conceptual diagram illustrating a phase shift control example using the phase shifter according to the second example embodiment.

FIG. 9 is a conceptual diagram illustrating an example of a configuration of a phase shifter according to a third example embodiment.

FIG. 10 is a conceptual diagram illustrating a phase shift control example using the phase shifter according to the third example embodiment.

FIG. 11 is a conceptual diagram illustrating a phase shift control example using the phase shifter according to the third example embodiment.

FIG. 12 is a conceptual diagram illustrating an example of a configuration of a phase shifter according to a fourth example embodiment.

FIG. 13 is a conceptual diagram illustrating an example of a configuration of the phase shifter according to a fifth example embodiment.

FIG. 14 is a conceptual diagram illustrating an example of a configuration of an antenna device according to a sixth example embodiment.

FIG. 15 is a cross-sectional view of part of the antenna device according to the sixth example embodiment.

FIG. 16 is a conceptual diagram of part of the antenna device according to the sixth example embodiment.

FIG. 17 is a block diagram illustrating an example of a configuration of the antenna device according to the sixth example embodiment.

FIG. 18 is a conceptual diagram illustrating an example of a configuration of a phase shifter according to ae seventh example embodiment.

FIG. 19 is a block diagram illustrating an example of a hardware configuration that implements control and processing of each example embodiment.

### EXAMPLE EMBODIMENT

Hereinafter, embodiments of the present invention will be described with reference to the drawings. However, the example embodiments described below have technically preferable limitations for carrying out the present invention, but the scope of the present invention is not limited to the following. In all the drawings used in the following description of the example embodiment, the same reference numerals are given to the same parts unless there is a particular reason. In the following example embodiments, repeated description of similar configurations and operations may be omitted.

### First Example Embodiment

First, a phase shifter according to a first example embodiment will be described with reference to the drawings. The phase shifter of the present example embodiment is mounted on an antenna device including a patch antenna that is a type of planar antenna. Hereinafter, an example in which a radio wave to be transmitted is transmitted from the antenna device will be described. The antenna device can also be applied to reception of a radio wave to be received arriving from the outside. Hereinafter, description of a transmission device that transmits a radio wave from the antenna device and a reception device that receives a radio wave received by the antenna device will be omitted. For example, the antenna device of the present example embodiment is used to transmit and receive a signal to be transmitted/received in a high frequency band used in mobile communication after the fifth-generation mobile communication.

### Configuration

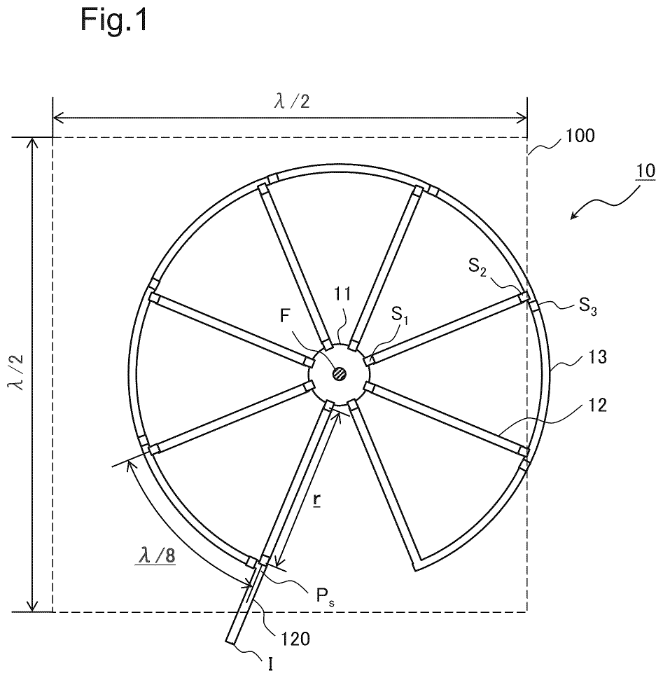

FIG. 1 is a conceptual diagram illustrating an example of a configuration of a phase shifter 10 according to the present example embodiment. The phase shifter 10 has a wheel-shaped outer shape. The phase shifter 10 includes a hub portion 11, a spoke portion 12, a rim portion 13, and a switch group. The spoke portion 12 includes a plurality of radial transmission lines. The plurality of radial transmission lines is also referred to as radial lines. The rim portion 13 includes a plurality of arc-shaped transmission lines. The plurality of arc-shaped transmission lines is also referred to as arcuate lines. The switch group includes a switch S₁, a switch S₂, and a switch S₃.

The phase shifter 10 is disposed in association with a patch antenna 100 disposed at the position indicated by the dashed rectangle. The size of the patch antenna 100 is set in accordance with a wavelength 2 of the signal to be transmitted/received inside the substrate (not illustrated) on which the phase shifter 10 is mounted. The wavelength 2 corresponds to a value obtained by dividing the wavelength λ₀ in vacuum by the square root of the relative dielectric constant εᵣ of the substrate. In the example of FIG. 1, the patch antenna 100 is a square having a side length of λ/2. Details of the correspondence relationship between the phase shifter 10 and the patch antenna 100 will be described in the sixth example embodiment to be described later.

The hub portion 11 is a disk-shaped conductor including a center point of the phase shifter 10. The hub portion 11 is electrically connected to a power-feeding point F of the patch antenna 100. The position of the power-feeding point F is a position deviated from the position (center) where the two diagonals of the patch antenna 100 intersect by the characteristic impedance. The hub portion 11 is electrically connected to the radial line included in the spoke portion 12 via the switch S₁. The material of the hub portion 11 is not limited as long as it has electrical conductivity.

The spoke portion 12 includes a plurality of radial lines. In the example of FIG. 1, the spoke portion 12 includes eight radial lines. The line length of the radial line is r (r is a real number). The first end of the radial line is connected to the switch S₁. The radial line is electrically connected to the hub portion 11 via the switch S₁. The second end of the radial line is connected to the switch S₂. The second end of the radial line is electrically connected to any of the arcuate lines included in the rim portion 13 via the switch S₂. The material of the radial line is not limited as long as it has electrical conductivity.

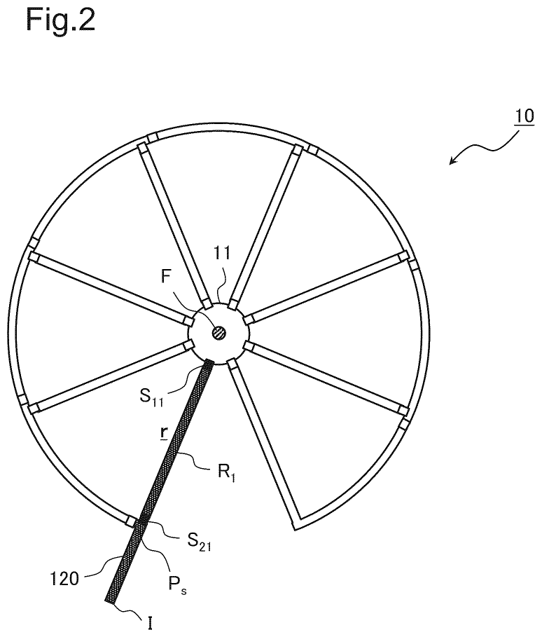

The radial lines R included in the spoke portion 12 are referred to as R₁, R₂, R₃, R₄, R₅, R₆, R₇, and R₈ clockwise in order from the line closer to the start point Pₛ. In FIG. 1, reference signs of a plurality of radial lines are omitted. The lower left radial line R₁ in FIG. 1 is connected to the switch S₂. The radial line R₁ is electrically connected to a signal input unit 120 including the start point Pₛ via the switch S₂. The signal input unit 120 is made of the same material as the radial line R. A signal to be transmitted is input to the signal input unit 120 from an input end I toward the start point Pₛ. The lower right radial line R₈ and the arcuate line in FIG. 1 are integrated without via the switch S₂. In FIGS. 2 to 4, reference signs of a plurality of radial lines are appropriately used (there are reference signs that are not used).

The rim portion 13 includes a plurality of arcuate lines. In the example of FIG. 1, the rim portion 13 includes seven arcuate lines. The line length of the arcuate line is set to a length (λ/8) that is ⅛ of the wavelength λ of the signal to be transmitted/received in the substrate on which the phase shifter 10 is mounted. The line length of the arcuate line corresponds to a length obtained by dividing the circumference of a circle centered on the hub portion 11 into eight equal parts.

The first end of the arcuate line is connected to the switch S₂ and the switch S₃. The arcuate line is electrically connected to the second end of any radial line included in the spoke portion 12 via the switch S₂. The arcuate line is electrically connected to the arcuate line adjacent clockwise via the switch S₃. The second end of the arcuate line is connected to another switch S₃. The arcuate line is electrically connected to the arcuate line adjacent counterclockwise via another switch S₃. The material of the rim portion 13 is not limited as long as it has electrical conductivity.

The arcuate lines C included in the rim portion 13 are referred to as C₁, C₂, C₃, C₄, C₅, C₆, and C₇ clockwise in order from the line closer to the start point Pₛ. In FIG. 1, reference signs of a plurality of arcuate lines are omitted. The lower left arcuate line C₁ in FIG. 1 is connected to the switch S₃. The arcuate line C₁ is electrically connected to the signal input unit 120 including the start point Pₛ via the switch S₃. The arcuate line C₇ at the lower right of FIG. 1 and the radial line are integrated without via the switch S₂. An arcuate line is not disposed between the arcuate line C₁ and the arcuate line C₇, and an interval is provided therebetween. In FIGS. 2 to 4, reference signs of a plurality of arcuate lines are appropriately used (there are reference signs that are not used).

The switch group includes eight switches S₁. The switch group includes seven switches S₂ and seven switches S₃. For example, the switches S₂ and S₃ disposed close to each other may be configured as a single switch having three terminals. The structure and the material of the switch included in the switch group are not limited as long as the switch can be used as a microwave switch. For example, the switch may include a micro electro mechanical systems (MEMS) or a positive-intrinsic-negative (PIN) diode. For example, the switch may include a field effect transistor (FET). For example, a switch made of a material such as gallium nitride or gallium oxide can be used. For example, the switch may include a switching element including a thin film of vanadium dioxide VO₂.

The switch S₁ is disposed at the first end of the radial line included in the spoke portion 12. The switch S₁ is used to switch the connection between the hub portion 11 and the radial line. When the switch S₁ is in the ON state, the hub portion 11 and the radial line are electrically connected. When the switch S₁ is in the OFF state, the hub portion 11 and the radial line are not electrically connected.

The switch S₂ is disposed at the second end of the radial line included in the spoke portion 12. The switch S₂ is used to switch the connection between the radial line and the arcuate line. When the switch S₂ is in the ON state, the radial line and the arcuate line are electrically connected. When the switch S₂ is in the OFF state, the radial line and the arcuate line are not electrically connected.

The switch S₃ is disposed at the end of the arcuate line included in the rim portion 13. The switch S₃ is used to switch connection between two adjacent arcuate lines. When the switch S₃ is in the ON state, the two adjacent arcuate lines are electrically connected via the switch S₃. When the switch S₃ is in the OFF state, the two arcuate lines adjacent to each other via the switch S₃ are not electrically connected.

### [Phase Control]

Next, three control examples of the phase control using the phase shifter 10 will be described. The phase of the signal input from the start point Pₛ is controlled by controlling the states of the plurality of switches (switch S₁, switch S₂, switch S₃) included in the switch. For example, a control unit (not illustrated) controls a phase shift amount by the phase shifter 10. In the following description of the phase control, in order to distinguish each switch, numbers are added to the end clockwise order from the portion close to the start point Pₛ (lower left in the drawing). For example, the switch S₁ connected to the radial line R₁ is denoted as S₁₁.

### <Control Example 1>

FIG. 2 is a conceptual diagram for describing the phase control example 1 using the phase shifter 10. The control example 1 corresponds to a phase shift reference (0 degrees) of another control example described later. Hereinafter, the phase shift amount of the control example 1 is set to the phase reference (0 degrees). In FIG. 2, a switch in an ON state and a line through which a signal propagates are indicated by hatching.

In the case of the example of FIG. 2, the switch S₁ and the switch S₂₁ are in the ON state. The other switches included in the switch group are in an OFF state. The signal input from the input end I reaches the hub portion 11 via the start point Pₛ, the switch S₂₁, the radial line R₁, and the switch S₁₁. The distance L from the start point Pₛ to the hub portion 11 corresponds to the length r of the radial line R₁. The signal input from the input end I is phase-shifted by the length r of the radial line from the phase at the start point Pₛ, and is transmitted as a radio wave to be transmitted from the patch antenna 100 connected to the hub portion 11. The phase shift amount of the control example 1 corresponds to the phase shift reference (0 degrees) of another control example described later.

### <Control Example 2>

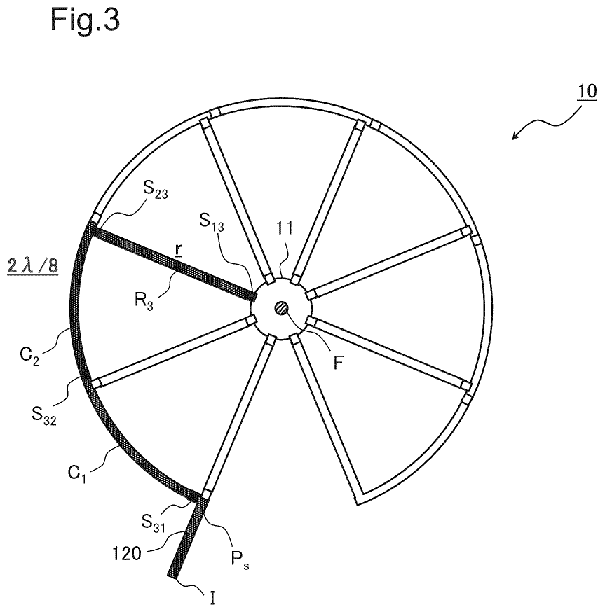

FIG. 3 is a conceptual diagram for describing the phase control example 2 using the phase shifter 10. The control example 2 is an example in which the phase of the signal is shifted by 90 degrees, as compared with the phase reference (0 degrees). In FIG. 3, a switch in an ON state and a line through which a signal propagates are indicated by hatching.

In the example of FIG. 3, the switch S₁₃, the switch S₂₃, and the switches S₃₁ to S₃₂ are in the ON state. The other switches included in the switch group are in an OFF state. The signal input from the input end I reaches the switch S₂₃ via the start point Pₛ, the switch S₃₁, the arcuate line C₁, the switch S₃₂, and the arcuate line C₂. The signal that has reached the switch S₂₃ reaches the hub portion 11 via the radial line R₃ and the switch S₁₃. The distance L from the start point Pₛ to the hub portion 11 corresponds to the sum of the lengths of the arcuate lines C₁ to C₂ and the radial line R₁. That is, the distance L is r+2×λ/8. In the difference from the phase shift amount at the phase reference (0 degrees), the length of the radial line is canceled out. The distance of 2/8×λ(=λ/4) indicates that the phase is shifted by 90 degrees with respect to the phase reference (0 degrees). The signal input from the input end I is phase-controlled by 90 degrees from the phase reference (0 degrees), and is transmitted as a radio wave to be transmitted from the patch antenna 100 connected to the hub portion 11.

### <Control Example 3>

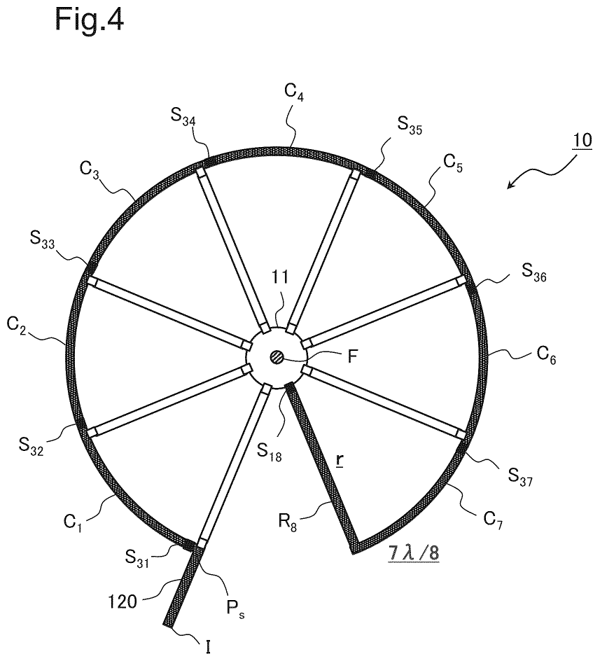

FIG. 4 is a conceptual diagram for describing the phase control example 3 using the phase shifter 10. The control example 3 is an example in which the phase of the signal is shifted by 315 degrees, as compared with the phase reference (0 degrees). In FIG. 4, a switch in an ON state and a line through which a signal propagates are indicated by hatching.

In the example of FIG. 4, the switch S₁₈ and the switches S₃₁ to S₃₇ are in the ON state. The other switches included in the switch group are in an OFF state. The signal input from the input end I reaches the switch S₃₅ via the start point Pₛ, the switch S₃₁, the arcuate line C₁, the switch S₃₂, the arcuate line C₂, the switch S₃₃, the arcuate line C₃, the switch S₃₄, and the arcuate line C₄. The signal that has reached the switch S₃₅ reaches the hub portion 11 via the arcuate line C₅, the switch S₃₆, the arcuate line C₆, the switch S₃₇, the arcuate line C₇, the radial line R₈, and the switch S₁₈. The distance L from the start point Pₛ to the hub portion 11 corresponds to the sum of the lengths of the arcuate lines C₁ to C₇ and the radial line R₁. That is, the distance L is r+7×λ/8. In the difference from the phase shift amount at the phase reference (0 degrees), the length of the radial line is canceled out. The distance of ⅞×λ indicates that the phase is shifted by 315 degrees with respect to the phase reference (0 degrees). The signal input from the input end I is phase-controlled by 315 degrees from the phase reference (0 degrees), and is transmitted as a radio wave to be transmitted from the patch antenna 100 connected to the hub portion 11.

As in the control examples 1 to 3 of FIGS. 2 to 4, the phase shifter 10 can perform phase control in increments of 45 degrees. The control examples 1 to 3 in FIGS. 2 to 4 are an example, and does not limit the phase control by the phase shifter 10.

As described above, the phase shifter according to the present example embodiment includes the hub portion, the spoke portion, the rim portion, and the switch group. The hub portion is connected to the power-feeding point of the patch antenna. The switch group includes a plurality of switches. The spoke portions are disposed radially centered on the hub portion. The spoke portion includes a plurality of radial lines electrically connected to the hub portion via any of the plurality of switches. The rim portion is disposed along an arc centered on the hub portion. The rim portion includes a plurality of arcuate lines electrically connected to the plurality of radial lines via any of the plurality of switches.

The phase shifter of the present example embodiment can control the phase shift amount of the radio wave regardless of whether the radio wave to be transmitted/received is a circularly polarized wave or a linearly polarized wave. The phase shifter of the present example embodiment has a circular shape and can be formed compactly. Therefore, the phase shifter of the present example embodiment can be accommodated below the patch antenna. That is, the phase shifter of the present example embodiment can be applied to a patch antenna having a size related to the wavelength of the signal to be transmitted/received regardless of the polarization state of the radio wave to be transmitted/received.

In an aspect of the present example embodiment, the hub portion, the switch group, the spoke portion, and the rim portion are formed on the same substrate. The spoke portion includes eight radial lines. The rim portion includes seven arcuate lines. The patch antennas are square. One side of the patch antenna corresponds to a length of ½ of the wavelength of the signal to be transmitted/received in the substrate. The line length of each of the plurality of arcuate lines included in the rim portion is ⅛ of the wavelength of the signal to be transmitted/received in the substrate. According to the phase shifter of the present aspect, the phase of the signal to be transmitted/received can be controlled in increments of 45 degrees.

In an aspect of the present example embodiment, the plurality of switches included in the switch group is switching elements including a thin film of vanadium dioxide. According to the present aspect, a phase shifter including a small switch utilizing phase transition of vanadium dioxide can be achieved.

### Second Example Embodiment

Next, a phase shifter according to a second example embodiment will be described with reference to the drawings. The phase shifter of the present example embodiment is different from that of the first example embodiment in which a bypass line that bypasses an adjacent radial line is included.

### Configuration

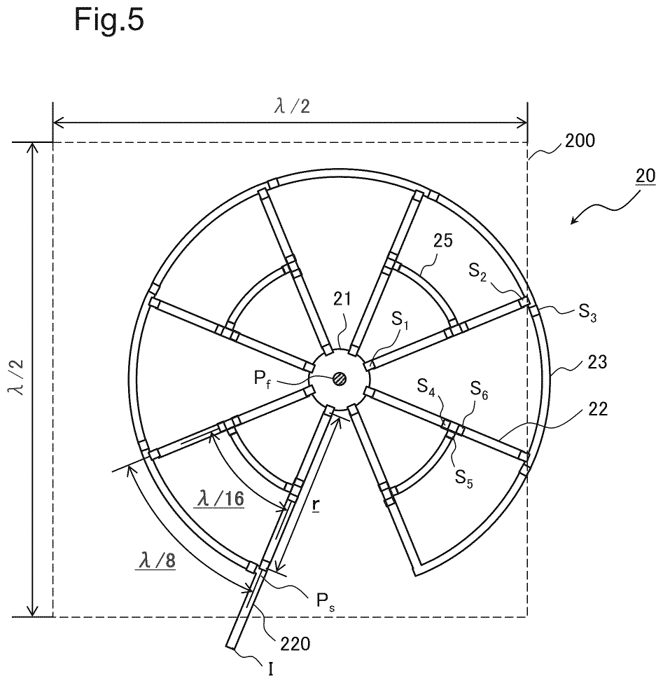

FIG. 5 is a conceptual diagram illustrating an example of a configuration of a phase shifter 20 according to the present example embodiment. The phase shifter 20 has a wheel-shaped outer shape. The phase shifter 20 includes a hub portion 21, a spoke portion 22, a rim portion 23, a bypass portion 25, and a switch group. The spoke portion 22 includes a plurality of first radial lines and a plurality of second radial lines. The first radial line and the second radial line connected in series constitute a radial line extending from the hub portion 21 to the rim portion 23. The bypass portion 25 includes a plurality of bypass lines. The rim portion 23 includes a plurality of arcuate lines. The switch group includes a switch S₁, a switch S₂, a switch S₃, a switch S₄, a switch S₅, and a switch S₆.

The phase shifter 20 is disposed in association with a patch antenna 200 disposed at the position indicated by the dashed rectangle. The size of the patch antenna 200 is set in accordance with the wavelength λ of the signal to be transmitted/received in the substrate (not illustrated) on which the phase shifter 20 is mounted. In the example of FIG. 5, the patch antenna 200 is a square having a side length of λ/2. Details of the correspondence relationship between the phase shifter 20 and the patch antenna 200 will be described in the sixth example embodiment to be described later.

The hub portion 21 is a disk-shaped conductor including a center point of the phase shifter 20. The hub portion 21 is electrically connected to the power-feeding point F of the patch antenna 200. The position of the power-feeding point F is a position deviated from the position (center) where the two diagonals of the patch antenna 200 intersect by the characteristic impedance. The hub portion 21 is connected to the switch S₁. The hub portion 21 is electrically connected to the plurality of first radial lines included in the spoke portion 22 via the switch S₁. The material of the hub portion 21 is not limited as long as it has electrical conductivity.

The spoke portion 22 includes a plurality of first radial lines. In the example of FIG. 5, the spoke portion 22 includes eight first radial lines. The first end of the first radial line is connected to the switch S₁. The first radial line is electrically connected to the hub portion 21 via the switch S₁. The second end of the first radial line is connected to the switch S₄. The first radial line is electrically connected to any of the second radial lines included in the spoke portion 22 via the switch S₄ and the switch S₆. The first radial line is connected in series with any of the second radial lines included in the spoke portion 22. The sum of the line lengths of the first radial line and the second radial line connected in series is r (r is a real number). The first radial line is electrically connected to any of the bypass lines included in the bypass portion 25 via the switch S₄ and the switch S₅. The material of the first radial line is not limited as long as it has electrical conductivity.

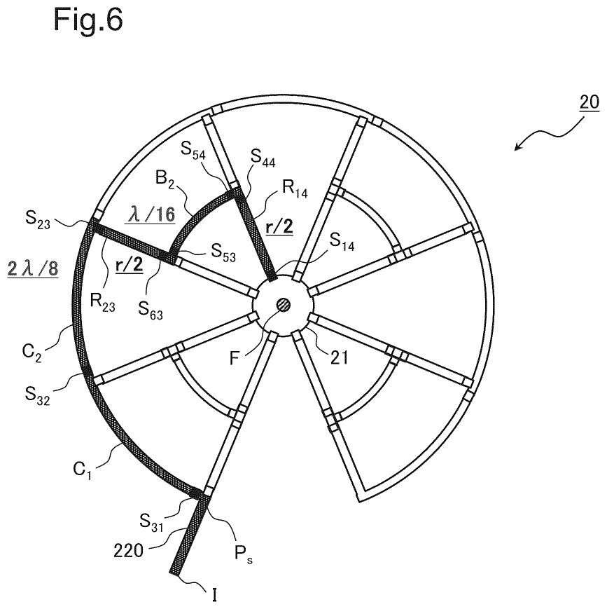

The first radial lines included in the spoke portion 22 are denoted as R₁₁-, R₁₂-, R₁₃-, R₁₄-, R₁₅-, R₁₆-, R₁₇-, and R₁₈ clockwise in order from the line closer to the start point Pₛ. In FIG. 5, reference signs of a plurality of first radial lines are omitted. In FIGS. 6 to 8, reference signs of a plurality of first radial lines are appropriately used (there are reference signs that are not used).

The spoke portion 22 includes a plurality of second radial lines. In the example of FIG. 5, the spoke portion 22 includes eight second radial lines. The first end of the second radial line is connected to the switch S₄. The second radial line is electrically connected to the first radial line connected in series via the switch S₄ and the switch S₆. The second radial line is electrically connected to any of the bypass lines included in the bypass portion 25 via the switch S₅ and the switch S₆. The second end of the second radial line is connected to the switch S₂. The second radial line is electrically connected to any of the arcuate lines included in the rim portion 23 via the switch S₂. The material of the radial line is not limited as long as it has electrical conductivity.

The second radial lines included in the spoke portion 22 are referred to as R₂₁-, R₂₂-, R₂₃-, R₂₄-, R₂₅-, R₂₆-, R₂₇-, and R₂₈ clockwise in order from the line closer to the start point Pₛ. In FIG. 5, reference signs of a plurality of second radial lines are omitted. The second radial line R₂₁ at the lower left in FIG. 5 is connected to a signal input unit 220 including the start point Pₛ via the switch S₂. The second radial line R₂₈ at the lower right of FIG. 5 and the arcuate line included in the rim portion 23 are integrated without via the switch S₂. In FIGS. 6 to 8, reference signs of a plurality of second radial lines are appropriately used (there are reference signs that are not used).

The rim portion 23 includes a plurality of arcuate lines. In the example of FIG. 5, the rim portion 23 includes seven arcuate lines. The line length of the arcuate line is set to a length (λ/8) that is ⅛ of the wavelength λ of the signal to be transmitted/received in the substrate on which the phase shifter 20 is mounted. The line length of the arcuate line corresponds to a length obtained by dividing the circumference of a circle centered on the hub portion 21 into eight equal parts.

The first end of the arcuate line included in the rim portion 23 is connected to the switch S₂ and the switch S₃. The arcuate line is electrically connected to any of the second radial lines included in the spoke portion 22 via the switch S₂. The arcuate line is electrically connected to the arcuate line adjacent clockwise via the switch S₃. The second end of the arcuate line is connected to another switch S₃. The arcuate line is electrically connected to the arcuate line adjacent counterclockwise via another switch S₃. The material of the rim portion 23 is not limited as long as it has electrical conductivity.

The arcuate lines C included in the rim portion 23 are referred to as C₁, C₂, C₃, C₄, C₅, C₆, and C₇ clockwise in order from the line closer to the start point Pₛ. In FIG. 5, reference signs of a plurality of arcuate lines are omitted. A lower left arcuate line C₁ in FIG. 5 is connected to the switch S₃. The arcuate line C₁ is connected to the signal input unit 220 including the start point Pₛ via the switch S₃. The arcuate line C₇ at the lower right of FIG. 5 and the second radial line are integrated without via the switch S₂. An arcuate line is not disposed between the arcuate line C₁ and the arcuate line C₇, and an interval is provided therebetween. In FIGS. 6 to 8, reference signs of a plurality of arcuate lines are appropriately used (there are reference signs that are not used).

The bypass portion 25 includes a plurality of bypass lines. The bypass line is a transmission line that electrically connects adjacent radial lines. In the example of FIG. 5, the bypass portion 25 includes four bypass lines. The number of bypass lines may be equal to or less than three, or equal to or more than five. The bypass line may be provided at a position other than the position illustrated in FIG. 5. The bypass line has an arc shape. The line length of the bypass line is set to a length (λ/16) that is 1/16 of the wavelength λ of the signal to be transmitted/received in the substrate on which the phase shifter 20 is mounted. The end of the bypass line is connected to the switch S₅. The bypass line is electrically connected to any of the first radial lines included in the spoke portion 22 via the switch S₄ and the switch S₅. The end of the bypass line is electrically connected to any of the second radial lines included in the spoke portion 22 via the switch S₅ and the switch S₆. The material of the bypass line is not limited as long as it has electrical conductivity.

The bypass lines included in the bypass portion 25 are denoted as B₁-, B₂-, B₃-, and B₄ clockwise in order from the line closer to the start point Pₛ. In FIG. 5, reference signs of a plurality of bypass lines are omitted. In FIGS. 6 to 8, reference signs of a plurality of bypass lines are appropriately used (there are reference signs that are not used).

The switch group includes eight switches S₁. The switch group includes seven switches S₂ and seven switches S₃. The switch group includes eight switches S₄, eight switches S₅, and eight switches S₆. For example, closely disposed switches may be configured as a single switch. The structure and the material of the switch included in the switch group are not limited as long as the switch can be used as a microwave switch. For example, the switch may include a MEMS, a PIN diode, an FET, or the like. For example, a switch made of a material such as gallium nitride or gallium oxide can be used. For example, the switch may include a switching element including a thin film of vanadium dioxide VO₂-.

The switch S₁ is disposed at the first end of the first radial line included in the spoke portion 22. The switch S₁ is used to switch the connection between the hub portion 21 and the first radial line. When the switch S₁ is in the ON state, the hub portion 21 and the first radial line are electrically connected. When the switch S₁ is in the OFF state, the hub portion 21 and the first radial line are not electrically connected.

The switch S₂ is disposed at the second end of the second radial line included in the spoke portion 22. The switch S₂ is used to switch the connection between the second radial line and the arcuate line. When the switch S₂ is in the ON state, the second radial line and the arcuate line are electrically connected. When the switch S₂ is in the OFF state, the second radial line and the arcuate line are not electrically connected.

The switch S₃ is disposed at the end of the arcuate line included in the rim portion 23. The switch S₃ is used to switch connection between two adjacent arcuate lines. When the switch S₃ is in the ON state, the two adjacent arcuate lines are electrically connected via the switch S₃. When the switch S₃ is in the OFF state, the two arcuate lines adjacent to each other via the switch S₃ are not electrically connected.

The switch S₄ is disposed at the second end of the first radial line included in the spoke portion 22. The switch S₅ is disposed at the end of the bypass line included in the bypass portion 25. The switch S₆ is disposed at the first end of the second radial line included in the spoke portion 22. The switch S₄, the switch S₅, and the switch S₆ are used for switching connection of the first radial line, the second radial line, and the bypass line. When the switch S₄ and the switch S₅ are in the ON state and the switch S₆ is in the OFF state, the first radial line and the bypass line are electrically connected. When the switch S₄ is in the OFF state and the switches S₅ and S₆ are in the ON state, the bypass line and the second radial line are electrically connected. When the switch S₄ and the switch S₆ are in the ON state and the switch S₅ is in the OFF state, the first radial line and the second radial line are electrically connected. In a normal use situation, not all of the switch S₄, the switch S₅, and the switch S₆ are set to the ON state.

### [Phase Control]

Next, three control examples of the phase control using the phase shifter 20 will be described. The phase of the signal input from the start point Pₛ is controlled by controlling the states of the plurality of switches (switch S₁, switch S₂, switch S₃, switch S₄, switch S₅, switch S₆) included in the switch. For example, a control unit (not illustrated) controls a phase shift amount by the phase shifter 20. In the following description of the phase control, in order to distinguish each switch, numbers are added to the end clockwise order from the portion close to the start point Pₛ (lower left in the drawing). For example, the switch S₁ connected to the first radial line R₁₁ is denoted as S₁₁.

### <Control Example 1>

FIG. 6 is a conceptual diagram for describing the phase control example 1 using the phase shifter 20. In the control example 1, the phase of the signal input from the input end I is shifted by 112.5 degrees from the phase reference (0 degrees). In FIG. 6, a switch in an ON state and a line through which a signal propagates are indicated by hatching.

In the example of FIG. 6, the switch S₁₄, the switch S₂₃, the switches S₃₁ to S₃₂, the switch S₄₄, the switches S₅₃ to S₅₄, and the switch S₆₃ are in the ON state. The other switches included in the switch group are in an OFF state. The signal input from the input end I reaches the switch S₂₃ via the start point Pₛ, the switch S₃₁, the arcuate line C₁, the switch S₃₂, and the arcuate line C₂. The signal reaching the switch S₂₃ reaches the hub portion 21 via the second radial line R₂₃, the switch S₆₃, the switch S₅₃, the bypass line B₂, the switch S₅₄, the switch S₄₄, the first radial line R₁₄, and the switch S₁₄. The distance L from the start point Pₛ to the hub portion 21 corresponds to the sum of the lengths of the arcuate lines C₁ to C₂, the second radial line R₂₃, the bypass line B₂, and the first radial line R₁₄. That is, the distance L is r+5×80 /16. In the difference from the phase shift amount at the phase reference (0 degrees), the length of the radial line is canceled out. The distance of 5/16×λ indicates that the phase is shifted by 112.5 degrees with respect to the phase reference (0 degrees). The signal input from the input end I is phase-controlled by 112.5 degrees from the phase reference (0 degrees), and is transmitted as a radio wave to be transmitted from the patch antenna 200 connected to the hub portion 21.

### <Control Example 2>

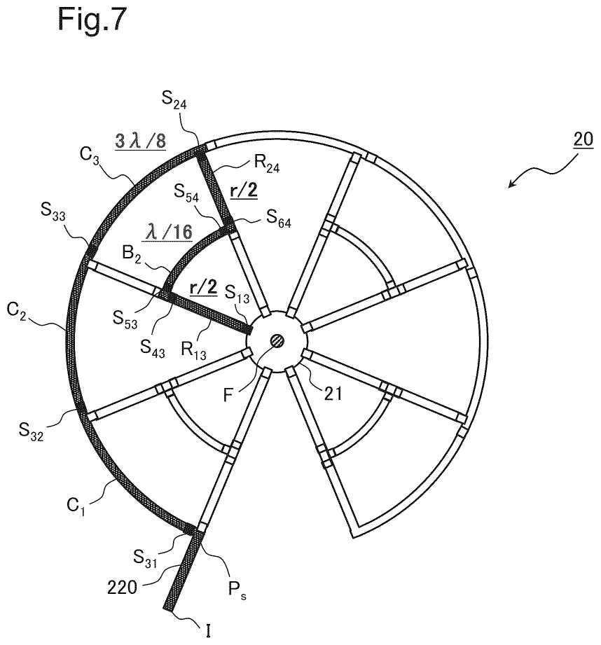

FIG. 7 is a conceptual diagram for describing the phase control example 2 using the phase shifter 20. The control example 2 is an example in which the phase of the signal is shifted by 157.5 degrees, as compared with the phase reference (0 degrees). In FIG. 7, a switch in an ON state and a line through which a signal propagates are indicated by hatching.

In the example of FIG. 7, the switch S₁₃, the switch S₂₄, the switches S₃₁ to S₃₃, the switch S₄₃, the switches S₅₃ to S₅₄, and the switch S₆₄ are in the ON state. The other switches included in the switch group are in an OFF state. The signal input from the input end I reaches the switch S₂₄ via the start point Pₛ, the switch S₃₁, the arcuate line C₁, the switch S₃₂, the arcuate line C₂, the switch S₃₃, and the arcuate line C₃. The signal reaching the switch S₂₄ reaches the hub portion 21 via the second radial line R₂₄, the switch S₆₄, the switch S₅₄, the bypass line B₂, the switch S₅₃, the switch S₄₃, the first radial line R₁₃, and the switch S₁₃. The distance L from the start point Pₛ to the hub portion 21 corresponds to the sum of the lengths of the arcuate lines C₁ to C₃, the second radial line R₂₄, the bypass line B₂, and the first radial line R₁₃. That is, the distance L is r+7×λ/16. In the difference from the phase shift amount at the phase reference (0 degrees), the length of the radial line is canceled out. The distance of 7/16×λ indicates that the phase is shifted by 157.5 degrees with respect to the phase reference (0 degrees). The signal input from the input end I is phase-controlled by 157.5 degrees from the phase reference (0 degrees), and is transmitted as a radio wave to be transmitted from the patch antenna 200 connected to the hub portion 21.

### <Control Example 3>

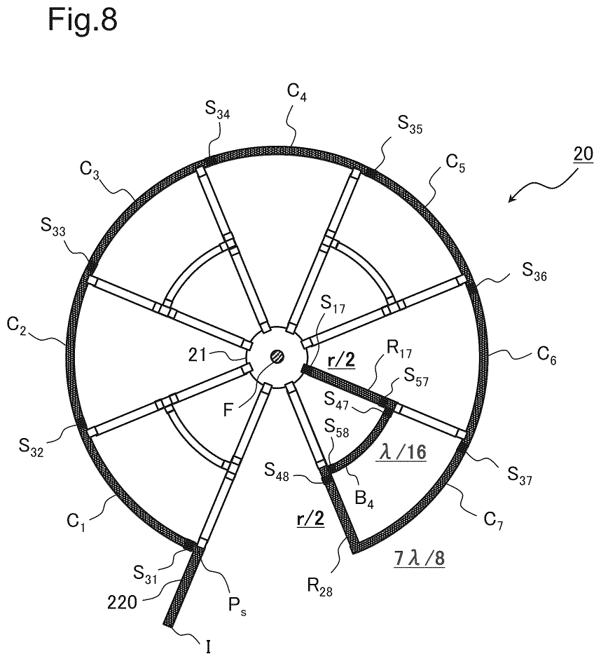

FIG. 8 is a conceptual diagram for describing the phase control example 3 using the phase shifter 20. The control example 3 is an example in which the phase of the signal is shifted by about 327.5 degrees, as compared with the phase reference (0 degrees). In FIG. 8, a switch in an ON state and a line through which a signal propagates are indicated by hatching.

In the example of FIG. 8, the switch S₁₇, the switches S₃₁ to S₃₇, the switches S₄₇ to S₄₈, and the switch S₅₇ are in the ON state. The other switches included in the switch group are in an OFF state. The signal input from the input end I reaches the switch S₃₅ via the start point Pₛ, the switch S₃₁, the arcuate line C₁, the switch S₃₂, the arcuate line C₂, the switch S₃₃, the arcuate line C₃, the switch S₃₄, and the arcuate line C₄. The signal reaching the switch S₃₅ reaches the switch S₄₈ via the arcuate line C₅, the switch S₃₆, the arcuate line C₆, the switch S₃₇, the arcuate line C₇, and the second radial line R₂₈. The signal that has reached the switch S₄₈ reaches the hub portion 21 via the bypass line B₄, the switch S₄₇, the switch S₅₇, the first radial line R₁₇, and the switch S₁₇. The distance L from the start point Pₛ to the hub portion 21 corresponds to the sum of the lengths of the arcuate lines C₁ to C₇, the second radial line R₂₈, the bypass line B₄, and the first radial line R₁₇. That is, the distance L is r+15×λ/16. In the difference from the phase shift amount at the phase reference (0 degrees), the length of the radial line is canceled out. The distance of 15/16×λ indicates that the phase is shifted by 337.5 degrees with respect to the phase reference (0 degrees) of the control example 1. The signal input from the input end I is phase-controlled by 337.5 degrees from the phase reference (0 degrees), and is transmitted as a radio wave to be transmitted from the patch antenna 200 connected to the hub portion 21.

As in the control examples 1 to 3 of FIGS. 6 to 8, the phase shifter 20 can perform phase control with a resolution of 22.5 degrees. The control examples in FIGS. 6 to 8 are an example, and do not limit the phase control by the phase shifter 20.

As described above, the phase shifter according to the present example embodiment includes the hub portion, the spoke portion, the rim portion, the bypass portion, and the switch group. The hub portion is connected to the power-feeding point of the patch antenna. The switch group includes a plurality of switches. The spoke portions are disposed radially centered on the hub portion. The spoke portion includes a plurality of radial lines electrically connected to the hub portion via any of the plurality of switches. The rim portion is disposed along an arc centered on the hub portion. The rim portion includes a plurality of arcuate lines electrically connected to the plurality of radial lines via any of the plurality of switches. The bypass portion includes at least one bypass line that bypasses two adjacent radial lines. The plurality of radial lines includes a first radial line and a second radial line. The first end of the first radial line is electrically connected to the hub portion via any of the plurality of switches. The second end of the first radial line is electrically connected to the end of any bypass line included in the bypass portion and the first end of the second radial line via any of the plurality of switches. The first end of the second radial line is electrically connected to the end of any bypass line included in the bypass portion and the second end of the first radial line via any of the plurality of switches. The second end of the second radial line is electrically connected to the end of any of the arcuate lines included in the rim portion.

The phase shifter of the present example embodiment includes a bypass line shorter than the arcuate line. Therefore, the phase shifter of the present example embodiment can improve the resolution of the phase shift amount of the radio wave, as compared with the phase shifter of the first example embodiment.

In an aspect of the present example embodiment, the hub portion, the switch group, the spoke portion, and the rim portion are formed on the same substrate. The spoke portion includes eight radial lines. The rim portion includes seven arcuate lines. The patch antennas are square. One side of the patch antenna corresponds to a length of ½ of the wavelength of the signal to be transmitted/received in the substrate. The line length of each of the plurality of arcuate lines included in the rim portion is ⅛ of the wavelength of the signal to be transmitted/received in the substrate. The line length of the bypass line is 1/16 of the wavelength of the signal to be transmitted/received in the substrate. According to the phase shifter of the present aspect, the phase of the signal to be transmitted/received can be controlled in increments of about 22.5 degrees.

### Third Example Embodiment

Next, a phase shifter according to a third example embodiment will be described with reference to the drawings. The phase shifter of the present example embodiment is different from the first to second example embodiments in which two types of bypass lines bypassing adjacent radial lines are included.

### Configuration

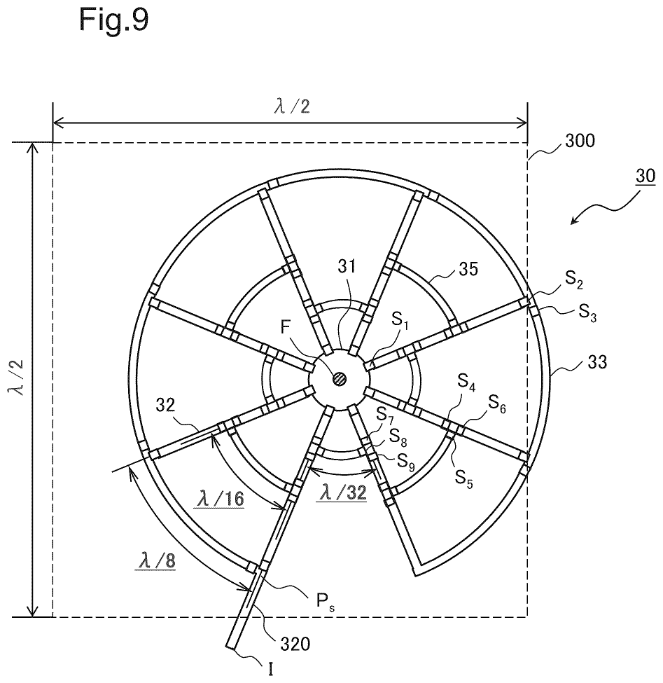

FIG. 9 is a conceptual diagram illustrating an example of a configuration of a phase shifter 30 according to the present example embodiment. The phase shifter 30 has a wheel-shaped outer shape. The phase shifter 30 includes a hub portion 31, a spoke portion 32, a rim portion 33, a bypass portion 35, and a switch group. The spoke portion 32 includes a plurality of first radial lines, a plurality of second radial lines, and a plurality of third radial lines. The first radial line, the second radial line, and the third radial line connected in series constitute a radial line extending from the hub portion 31 to the rim portion 33. The bypass portion 35 includes a plurality of first bypass lines and a plurality of second bypass lines. The rim portion 33 includes a plurality of arcuate lines. The switch group includes a switch S₁, a switch S₂, a switch S₃, a switch S₄, a switch S₅, a switch S₆, a switch S₇, a switch S₈, and a switch S₉.

The phase shifter 30 is disposed in association with a patch antenna 300 disposed at the position indicated by the dashed rectangle. The size of the patch antenna 300 is set in accordance with the wavelength λ of the signal to be transmitted/received in the substrate (not illustrated) on which the phase shifter 30 is mounted. The wavelength λ corresponds to a value obtained by dividing the wavelength λ₀ in vacuum by the square root of the relative dielectric constant εᵣ of the substrate. In the example of FIG. 9, the patch antenna 300 is a square having a side length of λ/2. Details of the correspondence relationship between the phase shifter 30 and the patch antenna 300 will be described in the sixth example embodiment to be described later.

The hub portion 31 is a disk-shaped conductor including a center point of the phase shifter 30. The hub portion 31 is electrically connected to the power-feeding point F of the patch antenna 300. The position of the power-feeding point F is a position deviated from the position (center) where the two diagonals of the patch antenna 300 intersect by the characteristic impedance. The hub portion 31 is connected to the switch S₁. The hub portion 31 is electrically connected to the first radial line constituting the spoke portion 32 via the switch S₁. The material of the hub portion 31 is not limited as long as it has electrical conductivity.

The spoke portion 32 includes a plurality of first radial lines. In the example of FIG. 9, the spoke portion 32 includes eight first radial lines. The first end of the first radial line is connected to the switch S₁. The first radial line is electrically connected to the hub portion 31 via the switch S₁. The second end of the first radial line is connected to the switch S₇. The first radial line is electrically connected to any of the second radial lines included in the spoke portion 32 via the switch S₇ and the switch S₉. The second end of the first radial line is electrically connected to any of the second bypass lines included in the bypass portion 35 via the switch S₇ and the switch S₈. The material of the first radial line is not limited as long as it has electrical conductivity.

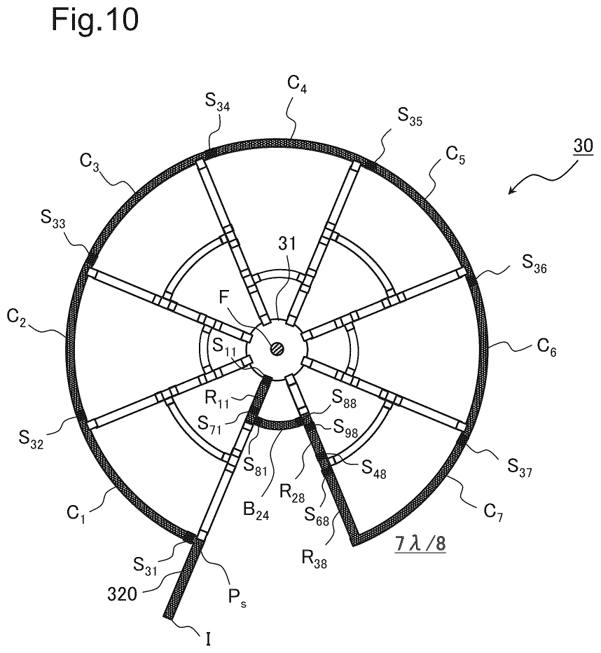

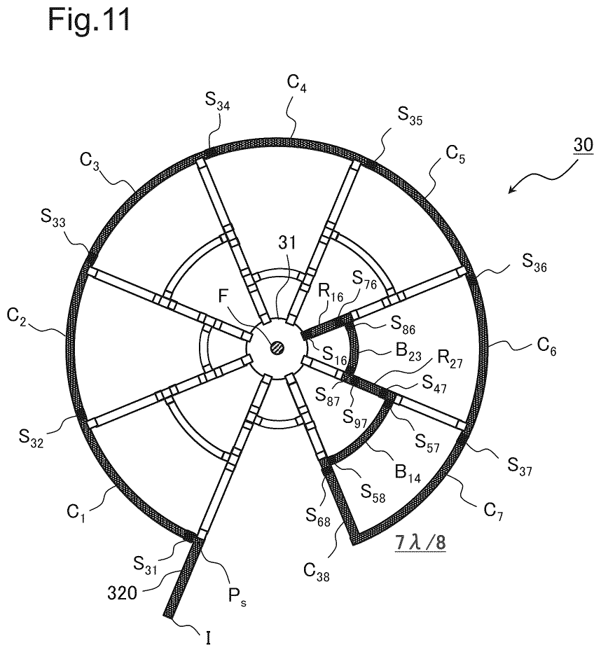

The first radial lines included in the spoke portion 32 are denoted as R₁₁, R₁₂, R₁₃, R₁₄, R₁₅, R₁₆, R₁₇, and R₁₈ clockwise in order from the line closer to the start point Pₛ. In FIG. 9, reference signs of a plurality of first radial lines are omitted. In FIGS. 10 to 11, reference signs of a plurality of first radial lines are appropriately used (there are reference signs that are not used).

The spoke portion 32 includes a plurality of second radial lines. In the example of FIG. 9, the spoke portion 32 includes eight second radial lines. The first end of the second radial line is connected to the switch S₉. The second radial line is electrically connected to any of the first radial lines included in the spoke portion 32 via the switch S₇ and the switch S₉. The second radial line is electrically connected to any of the second bypass lines included in the bypass portion 35 via the switch S₉ and the switch S₈. The second end of the second radial line is connected to the switch S₄. The second radial line is electrically connected to any of the third radial lines included in the spoke portion 32 via the switch S₄ and the switch S₆. The second radial line is electrically connected to any of the first bypass lines included in the bypass portion 35 via the switch S₄ and the switch S₅.

The second radial lines included in the spoke portion 32 are denoted as R₂₁, R₂₂, R₂₃, R₂₄, R₂₅, R₂₆, R₂₇, and R₂₈ clockwise in order from the line closer to the start point Pₛ. In FIG. 9, reference signs of a plurality of second radial lines are omitted. In FIGS. 10 to 11, reference signs of a plurality of second radial lines are appropriately used (there are reference signs that are not used).

The spoke portion 32 includes a plurality of third radial lines. In the example of FIG. 9, the spoke portion 32 includes eight third radial lines. The first end of the third radial line is connected to the switch S₆. The third radial line is electrically connected to any of the second radial lines included in the spoke portion 32 via the switch S₄ and the switch S₆. The first end of the third radial line is electrically connected to any of the first bypass lines included in the bypass portion 35 via the switch S₅ and the switch S₆. The second end of the third radial line is connected to the switch S₂. The third radial line is electrically connected to any of the arcuate lines included in the rim portion 33 via the switch S₂. The material of the radial line is not limited as long as it has electrical conductivity.

The third radial lines included in the spoke portion 32 are denoted as R₃₁, R₃₂, R₃₃, R₃₄, R₃₅, R₃₆, R₃₇, and R₃₈ clockwise in order from the line closer to the start point Pₛ. In FIG. 9, reference signs of a plurality of third radial lines are omitted. The third radial line R₃₁ at the lower left of FIG. 9 is connected to a signal input unit 320 including the start point Pₛ via the switch S₂. A signal to be transmitted is input to the signal input unit 320 from the input end I toward the start point Pₛ. The third radial line R₃₁ at the lower right of FIG. 9 and the arcuate line included in the rim portion 33 are integrated without via the switch S₂. In FIGS. 10 to 11, reference signs of a plurality of third radial lines are appropriately used (there are reference signs that are not used).

The rim portion 33 includes a plurality of arcuate lines. In the example of FIG. 9, the rim portion 33 includes seven arcuate lines. The line length of the arcuate line is set to a length (λ/8) that is ⅛ of the wavelength λ of the signal to be transmitted/received in the substrate on which the phase shifter 30 is mounted. The line length of the arcuate line corresponds to a length obtained by dividing the circumference of a circle centered on the hub portion 31 into eight equal parts.

The first end of the arcuate line included in the rim portion 33 is connected to the switch S₂ and the switch S₃. The arcuate line is electrically connected to any of the third radial lines included in the spoke portion 32 via the switch S₂. The arcuate line is electrically connected to the arcuate line adjacent clockwise via the switch S₃. The second end of the arcuate line is electrically connected to the first end of the arcuate line adjacent counterclockwise via another switch S₃. The material of the rim portion 33 is not limited as long as it has electrical conductivity.

The arcuate lines C included in the rim portion 33 are denoted as C₁, C₂, C₃, C₄, C₅, C₆, and C₇ clockwise in order from the line closer to the start point Pₛ. In FIG. 9, reference signs of a plurality of arcuate lines are omitted. The arcuate line C₁ at the lower left of FIG. 9 is connected to the signal input unit 320 including the start point Pₛ via the switch S₃. The lower right arcuate line C₇ and the third radial line in FIG. 9 are integrated without via the switch S₂. An arcuate line is not disposed between the arcuate line C₁ and the arcuate line C₇, and an interval is provided therebetween. In FIGS. 10 to 11, reference signs of a plurality of arcuate lines are appropriately used (there are reference signs that are not used).

The bypass portion 35 includes a plurality of first bypass lines. The first bypass line is a transmission line that electrically connects adjacent radial lines. In the example of FIG. 9, the bypass portion 35 includes four bypass lines. The number of the first bypass lines may be equal to or less than three, or equal to or more than five. The first bypass line may be provided at a position other than the position illustrated in FIG. 9. The first bypass line has an arc shape. The line length of the first bypass line is set to 1/16 (λ/16) of the wavelength λ of the signal to be transmitted/received in the substrate on which the phase shifter 30 is mounted.

The end of the first bypass line is connected to the switch S₅. The first bypass line is electrically connected to any of the second radial lines included in the spoke portion 32 via the switch S₄ and the switch S₅. The first bypass line is electrically connected to any of the third radial lines included in the spoke portion 32 via the switch S₅ and the switch S₆. The material of the first bypass line is not limited as long as it has electrical conductivity.

The first bypass lines included in the bypass portion 35 are denoted as B₁₁, B₁₂, B₁₃, and B₁₄ clockwise in order from the line closer to the start point Pₛ. In FIG. 9, reference signs of a plurality of first bypass lines are omitted. In FIGS. 10 to 11, reference signs of a plurality of first bypass lines are appropriately used (there are reference signs that are not used).

The bypass portion 35 includes a plurality of second bypass lines. The second bypass line is a transmission line that electrically connects adjacent radial lines. In the example of FIG. 9, the bypass portion 35 includes four second bypass lines. The number of the second bypass lines may be three or less, or five or more. The second bypass line may be provided at a position other than the position illustrated in FIG. 9. The second bypass line has an arc shape. The second bypass line is shorter than the first bypass line. The line length of the second bypass line is set to 1/32 (λ/32) of the wavelength λ of the signal to be transmitted/received in the substrate on which the phase shifter 30 is mounted.

The end of the second bypass line is connected to the switch S₈. The second bypass line is electrically connected to any of the first radial lines included in the spoke portion 32 via the switch S₇ and the switch S₈. The second bypass line is electrically connected to any of the second radial lines included in the spoke portion 32 via the switch S₈ and the switch S₉. The material of the additional bypass line is not limited as long as it has electrical conductivity.

The second bypass lines included in the bypass portion 35 are denoted as B₂₁, B₂₂, B₂₃, and B₂₄ clockwise in order from the start point Pₛ. In FIG. 9, reference signs of a plurality of second bypass lines are omitted. In FIGS. 10 to 11, reference signs of a plurality of second bypass lines are appropriately used (there are reference signs that are not used).

The switch group includes eight switches S₁. The switch group includes seven switches S₂ and seven switches S₃. The switch group includes eight switches S₄, eight switches S₅, eight switches S₆, eight switches S₇, eight switches S₈, and eight switches S₉. For example, closely disposed switches may be configured as a single switch having three terminals. The structure and the material of the switch included in the switch group are not limited as long as the switch can be used as a microwave switch. For example, the switch may include a MEMS, a PIN diode, an FET, or the like. For example, a switch made of a material such as gallium nitride or gallium oxide can be used. For example, the switch may include a switching element including a thin film of vanadium dioxide VO₂.

The switch S₁ is disposed at the first end of the first radial line included in the spoke portion 32. The switch S₁ is used to switch the connection between the hub portion 31 and the first radial line. When the switch S₁ is in the ON state, the hub portion 31 and the first radial line are electrically connected. When the switch S₁ is in the OFF state, the hub portion 31 and the first radial line are not electrically connected.

The switch S₂ is disposed at the second end of the third radial line included in the spoke portion 32. The switch S₂ is used to switch the connection between the third radial line and the arcuate line. When the switch S₂ is in the ON state, the third radial line and the arcuate line are electrically connected. When the switch S₂ is in the OFF state, the third radial line and the arcuate line are not electrically connected.

The switch S₃ is disposed at the end of the arcuate line included in the rim portion 33. The switch S₃ is used to switch connection between two adjacent arcuate lines. When the switch S₃ is in the ON state, the two adjacent arcuate lines are electrically connected via the switch S₃. When the switch S₃ is in the OFF state, the two arcuate lines adjacent to each other via the switch S₃ are not electrically connected.

The switch S₄ is disposed at the second end of the second radial line. The switch S₅ is disposed at the end of the first bypass line. The switch S₆ is disposed at the first end of the third radial line. The switch S₄, the switch S₅, and the switch S₆ are used for switching connection of the second radial line, the third radial line, and the first bypass line. When the switch S₄ and the switch S₅ are in the ON state and the switch S₆ is in the OFF state, the second radial line and the first bypass line are electrically connected. When the switch S₄ is in the OFF state and the switches S₅ and S₆ are in the ON state, the first bypass line and the third radial line are electrically connected. When the switch S₄ and the switch S₆ are in the ON state and the switch S₅ is in the OFF state, the second radial line and the third radial line are electrically connected. In a normal use situation, not all of the switch S₄, the switch S₅, and the switch S₆ are set to the ON state.

The switch S₇ is disposed at the second end of the first radial line. The switch S₈ is disposed at the end of the second bypass line. The switch S₉ is disposed at the first end of the second radial line. The switch S₇, the switch S₈, and the switch S₉ are used for switching connection of the first radial line, the second radial line, and the second bypass line. When the switches S₇ and S₈ are in the ON state and the switch S₉ is in the OFF state, the first radial line and the second bypass line are electrically connected. When the switch S₇ is in the OFF state and the switches S₈ and S₉ are in the ON state, the second bypass line and the second radial line are electrically connected. When the switch S₇ and the switch S₉ are in the ON state and the switch S₈ is in the OFF state, the first radial line and the second radial line are electrically connected. In a normal use situation, not all of the switch S₇, the switch S₈, and the switch S₉ are set to the ON state.

### [Phase Control]

Next, two control examples of the phase control using the phase shifter 30 will be described. The phase of the signal input from the start point Pₛ is controlled by controlling the states of the plurality of switches (S₁ to S₉) included in the switch. For example, a control unit (not illustrated) controls a phase shift amount by the phase shifter 30. In the following description of the phase control, in order to distinguish each switch, numbers are added to the end clockwise order from the portion close to the start point Ps (lower left in the drawing). For example, the switch S₁ connected to the first radial line R₁₁ is denoted as S₁₁.

### <Control Example 1>

FIG. 10 is a conceptual diagram for describing the phase control example 1 using the phase shifter 30. In the control example 1, the phase of the signal input from the input end I is shifted by about 326.3 degrees, as compared with the phase reference (0 degrees). In FIG. 10, a switch in an ON state and a line through which a signal propagates are indicated by hatching.

In the example of FIG. 10, the switch S₁₁, the switches S₃₁ to S₃₇, the switch S₄₈, the switch S₆₈, the switch S₇₁, the switch S₈₁, the switch S₈₈, and the switch S₉₈ are in the ON state. The other switches included in the switch group are in an OFF state. The signal input from the input end I reaches the switch S₃₅ via the start point Pₛ, the switch S₃₁, the arcuate line C₁, the switch S₃₂, the arcuate line C₂, the switch S₃₃, the arcuate line C₃, the switch S₃₄, and the arcuate line C₄. The signal reaching the switch S₃₅ reaches the switch S₆₈ via the arcuate line C₅, the switch S₃₆, the arcuate line C₆, the switch S₃₇, the arcuate line C₇, and the third radial line R₃₈. The signal reaching the switch S₆₈ reaches the hub portion 31 via the switch S₄₈, the second radial line R₂₈, the switch S₉₈, the switch S₈₈, the second bypass line B₂₄, the switch S₈₁, the switch S₇₁, the first radial line R₁₁, and the switch S₁₁. The distance L from the start point Pₛ to the hub portion 31 corresponds to the sum of the lengths of the arcuate lines C₁ to C₇, the third radial line R₃₈, the second radial line R₂₈, the second bypass line B₂₄, and the first radial line R₁₁. That is, the distance L is r+29×λ/32. In the difference from the phase shift amount at the phase reference (0 degrees), the length r of the radial line is canceled out. The distance of 29/32×λ indicates that the phase is shifted by about 326.3 degrees with respect to the phase reference (0 degrees). The signal input from the input end I is phase-shifted by about 326.3 degrees from the phase reference (0 degrees) and transmitted as a radio wave to be transmitted from the patch antenna 300 connected to the hub portion 31.

### <Control Example 2>

FIG. 11 is a conceptual diagram for describing the phase control example 2 using the phase shifter 30. The control example 2 is an example in which the phase of the signal is shifted by about 348.8 degrees, as compared with the phase reference (0 degrees). In FIG. 11, a switch in an ON state and a line through which a signal propagates are indicated by hatching.

In the example of FIG. 11, the switch S₁₆, the switches S₃₁ to S₃₇, the switch S₄₇, the switches S₅₇ to S₅₈, the switch S₆₈, the switch S₇₆, the switches S₈₆ to S₈₇, and the switch S₉₇ are in the ON state. The other switches included in the switch group are in an OFF state. The signal input from the input end I reaches the switch S₃₅ via the start point Pₛ, the switch S₃₁, the arcuate line C₁, the switch S₃₂, the arcuate line C₂, the switch S₃₃, the arcuate line C₃, the switch S₃₄, and the arcuate line C₄. The signal reaching the switch S₃₅ reaches the switch S₆₈ via the arcuate line C₅, the switch S₃₆, the arcuate line C₆, the switch S₃₇, the arcuate line C₇, and the third radial line R₃₈. The signal reaching the switch S₆₈reaches the switch S₅₈, the first bypass line B₁₄, the switch S₅₇, the switch S₄₇, the second radial line R₂₇, and the switch S₉₇. The signal that has reached the switch S₉₇ reaches the hub portion 31 via the switch S₈₇, the second bypass line B₂₃, the switch S₈₆, the switch S₇₆, the first radial line R₁₆, and the switch S₁₆. The distance L from the start point Pₛ to the hub portion 31 corresponds to the sum of the lengths of the arcuate lines C₁ to C₇, the third radial line R₃₈, the first bypass line B₁₄, the second radial line R₂₇, the second bypass line B₂₃, and the first radial line R₁₆. That is, the distance L is r+31×λ/32. In the difference from the phase shift amount at the phase reference (0 degrees), the length of the radial line is canceled out. The distance of 31/32×λ indicates that the phase is shifted by about 348.8 degrees with respect to the phase reference (0 degrees). The signal input from the input end I is phase-shifted by about 348.8 degrees from the phase reference (0 degrees) and transmitted as a radio wave to be transmitted from the patch antenna 300 connected to the hub portion 31.

As in the control examples 1 to 2 in FIGS. 10 to 11, the phase shifter 30 can perform phase control with a resolution of about 11.25 degrees. The control examples in FIGS. 10 to 11 are an example, and do not limit the phase control by the phase shifter 30.

As described above, the phase shifter according to the present example embodiment includes the hub portion, the spoke portion, the rim portion, the bypass portion, and the switch group. The hub portion is connected to the power-feeding point of the patch antenna. The switch group includes a plurality of switches. The spoke portions are disposed radially centered on the hub portion. The spoke portion includes a plurality of radial lines electrically connected to the hub portion via any of the plurality of switches. The rim portion is disposed along an arc centered on the hub portion. The rim portion includes a plurality of arcuate lines electrically connected to the plurality of radial lines via any of the plurality of switches. The bypass portion includes at least one first bypass line and at least one second bypass line bypassing two adjacent radial lines. The first bypass line has a line length longer than that of the second bypass line. The radial line includes a first radial line, a second radial line, and a third radial line. The first end of the first radial line is electrically connected to the hub portion via any of the plurality of switches. The second end of the first radial line is electrically connected to the end of any of the second bypass lines included in the bypass portion and the first end of the second radial line via any of the plurality of switches. The first end of the second radial line is electrically connected to the end of any of the second bypass lines included in the bypass portion and the second end of the first radial line via any of the plurality of switches. The second end of the second radial line is electrically connected to the end of any of the first bypass lines included in the bypass portion and the first end of the third radial line via any of the plurality of switches. The first end of the third radial line is electrically connected to the end of any of the first bypass lines included in the bypass portion and the second end of the second radial line via any of the plurality of switches. The second end of the third radial line is electrically connected to the end of any of the arcuate lines included in the rim portion.

The phase shifter of the present example embodiment includes two types of bypass lines having different lengths. Therefore, the phase shifter of the present example embodiment can further improve the resolution of the phase shift amount of the signal to be transmitted/received, as compared with the phase shifter of the second example embodiment.

In an aspect of the present example embodiment, the hub portion, the switch group, the spoke portion, and the rim portion are formed on the same substrate. The spoke portion includes eight radial lines. The rim portion includes seven arcuate lines. The patch antennas are square. One side of the patch antenna corresponds to a length of ½ of the wavelength of the signal to be transmitted/received in the substrate. The line length of the arcuate line is ⅛ of the wavelength of the signal to be transmitted/received in the substrate. The line length of the first bypass line is 1/16 of the wavelength of the signal to be transmitted/received in the substrate. The line length of the second bypass line is 1/32 of the wavelength of the signal to be transmitted/received in the substrate. According to the phase shifter of the present aspect, the phase of the signal to be transmitted/received can be controlled in increments of about 11.25 degrees.

### Fourth Example Embodiment

Next, a phase shifter according to a fourth example embodiment will be described with reference to the drawings. The phase shifter of the present example embodiment is different from that of the first to third example embodiments in that a bypass line is added to an arcuate line included in a rim portion. The bypass line added to the arcuate line included in the rim portion is also referred to as an additional bypass line. In the present example embodiment, an example in which an additional bypass line is added to the configuration of the second example embodiment will be described. The additional bypass line may be added to the configuration of the first or third example embodiment.

### Configuration

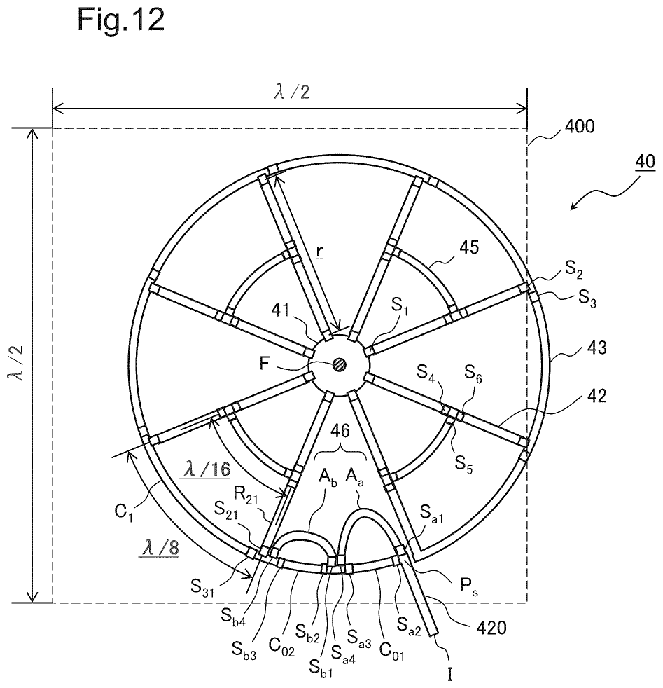

FIG. 12 is a conceptual diagram illustrating an example of a configuration of a phase shifter 40 according to the present example embodiment. The phase shifter 40 has a wheel-shaped outer shape. The phase shifter 40 includes a hub portion 41, a spoke portion 42, a rim portion 43, a bypass portion 45, an additional bypass portion 46, and a switch group. The spoke portion 42 includes a plurality of first radial lines and a plurality of second radial lines. The first radial line and the second radial line connected in series constitute a radial line extending from the hub portion 41 to the rim portion 43. The bypass portion 45 includes a plurality of bypass lines. The additional bypass portion 46 includes two additional bypass lines. The rim portion 43 includes a plurality of arcuate lines. The switch group includes a switch S₁, a switch S₂, a switch S₃, a switch S₄, a switch S₅, and a switch S₆. The switch group includes a first additional switch (Sₐ₁, Sₐ₂, Sₐ₃, Sₐ₄) and a second additional switch (S_{b1}, S_{b2}, S_{b3}, S_{b4}).

The phase shifter 40 is disposed in association with the patch antennas 400 disposed at the position indicated by the dashed rectangle. The size of the patch antenna 400 is set in accordance with the wavelength λ of the signal to be transmitted/received in the substrate (not illustrated) on which the phase shifter 40 is mounted. The wavelength λ corresponds to a value obtained by dividing the wavelength λ₀ in vacuum by the square root of the relative dielectric constant εᵣ of the substrate. In the example of FIG. 12, the patch antenna 400 is a square having a side length of λ/2. Details of the correspondence relationship between the phase shifter 40 and the patch antenna 400 will be described in the sixth example embodiment to be described later.

The hub portion 41 is a disk-shaped conductor including a center point of the phase shifter 40. The hub portion 41 is electrically connected to the power-feeding point F of the patch antenna 400. The position of the power-feeding point F is a position deviated from the position (center) where the two diagonals of the patch antenna 400 intersect by the characteristic impedance. The hub portion 41 is electrically connected to the plurality of first radial lines included in the spoke portion 42 via the plurality of switches S₁. The material of the hub portion 41 is not limited as long as it has electrical conductivity.

The spoke portion 42 includes a plurality of first radial lines. In the example of FIG. 12, the spoke portion 42 includes eight first radial lines. The first end of the first radial line is connected to the switch S₁. The first radial line is electrically connected to the hub portion 41 via the switch S₁. The second end of the first radial line is connected to the switch S₄. The first radial line is electrically connected to any of the second radial lines included in the spoke portion 42 via the switch S₄ and the switch S₆. The first radial line is electrically connected to any of the first bypass lines included in the bypass portion 45 via the switch S₄ and the switch S₅. The material of the first radial line is not limited as long as it has electrical conductivity.

The spoke portion 42 includes a plurality of second radial lines. In the example of FIG. 12, the spoke portion 42 includes eight second radial lines. The first end of the second radial line is connected to the switch S₆. The second radial line is electrically connected to any of the first radial lines included in the spoke portion 42 via the switch S₄ and the switch S₆. The first end of the second radial line is electrically connected to any of the bypass lines included in the bypass portion 45 via the switch S₆ and the switch S₅. The second end of the second radial line is connected to the switch S₂. The second radial line is electrically connected to any of the arcuate lines included in the rim portion 43 via the switch S₂. The material of the radial line is not limited as long as it has electrical conductivity.

The rim portion 43 includes a plurality of arcuate lines. In the example of FIG. 12, the rim portion 43 includes eight arcuate lines. The line length of the arcuate line is set to a length (λ/8) that is ⅛ of the wavelength λ of the signal to be transmitted/received in the substrate on which the phase shifter 40 is mounted. The line length of the arcuate line corresponds to a length obtained by dividing the circumference of a circle centered on the hub portion 41 into eight equal parts.

The first end of the arcuate line included in the rim portion 43 is connected to the switch S₂ and the switch S₃. The arcuate line is electrically connected to any of the second radial lines included in the spoke portion 42 via the switch S₂. The arcuate line is electrically connected to the arcuate line adjacent clockwise via the switch S₃. The second end of the arcuate line is electrically connected to the first end of the arcuate line adjacent counterclockwise via another switch S₂. The material of the rim portion 43 is not limited as long as it has electrical conductivity.

The lower right arcuate line and the second radial line in FIG. 12 are integrated without via the switch S₂. A first additional bypass line Aₐ and a second additional bypass line A_{b} included in the additional bypass portion 46 are disposed in the arcuate line at the lower center of FIG. 12. The arcuate line is divided with the first additional switch Sₐ₃ and the second additional switch S_{b2} interposed therebetween. The arcuate line in the section (right side) between the first additional switch Sₐ₂ and the first additional switch Sₐ₃ is referred to as an arcuate line C₀₁. The arcuate line C₀₁ is connected to a signal input unit 420 including the start point Pₛ via the first additional switch Sₐ₂. The arcuate line in the section (left side) between the second additional switch S_{b2} and the second additional switch S_{b3} is referred to as an arcuate line C₀₂.

The bypass portion 45 includes a plurality of bypass lines. The bypass line is a transmission line that electrically connects adjacent radial lines. In the example of FIG. 12, the bypass portion 45 includes four bypass lines. The number of bypass lines may be equal to or less than three, or equal to or more than five. The bypass line may be provided at a position other than the position illustrated in FIG. 12. The bypass line has an arc shape. The line length of the bypass line is set to a length (λ/16) that is 1/16 of the wavelength λ of the signal to be transmitted/received in the substrate on which the phase shifter 40 is mounted.

The end of the bypass line is connected to the switch S₅. The bypass line is electrically connected to any of the first radial lines included in the spoke portion 42 via the switch S₄ and the switch S₅. The bypass line is electrically connected to any of the second radial lines included in the spoke portion 42 via the switch S₅ and the switch S₆. The material of the bypass line is not limited as long as it has electrical conductivity.

The additional bypass portion 46 includes two additional bypass lines (first additional bypass line Aₐ, second additional bypass line A_{b}). The additional bypass line is provided in the arcuate line at the center lower portion. The additional bypass line is curved. The additional bypass line may be disposed at a position other than the position illustrated in FIG. 12.

The first end of the first additional bypass line Aₐ is connected to the first additional switch Sₐ₁. The first additional bypass line Aₐ is connected to the signal input unit 420 including the start point Pₛ via the first additional switch Sₐ₁. The second end of the first additional bypass line Aₐ is connected to the first additional switch Sₐ₄. The first additional bypass line Aₐ is electrically connected to the second additional bypass line A_{b} via the first additional switch Sₐ₄ and the second additional switch S_{b1}. The first additional bypass line Aₐ is electrically connected to the arcuate line C₀₂ via the first additional switch Sₐ₄ and the second additional switch S_{b2}. The difference between the line length of the first additional bypass line Aₐ and the line length of the arcuate line Con is set to a length (λ/32) that is 1/32 of the wavelength λ of the signal to be transmitted/received in the substrate on which the phase shifter 40 is mounted. The material of the first additional bypass line Aₐ is not limited as long as it has electrical conductivity.

The first end of the second additional bypass line A_{b} is connected to the second additional switch S_{b1}. The second additional bypass line A_{b} is electrically connected to the arcuate line C₀₁ via the second additional switch S_{b1} and the first additional switch Sₐ₃. The second additional bypass line A_{b} is electrically connected to the first additional bypass line Aₐ via the second additional switch S_{b1} and the first additional switch Sₐ₄. The second end of the second additional bypass line A_{b} is connected to the second additional switch S_{b4}. The second additional bypass line A_{b} is electrically connected to the second radial line R₂₁ via the second additional switch S_{b4} and the switch S₂₁. The second additional bypass line A_{b} is electrically connected to the arcuate line C₁ via the second additional switch S_{b4} and the switch S₃₁. The difference between the line length of the second additional bypass line A_{b} and the line length of the arcuate line C₀₂ is set to a length (λ/64) that is 1/64 of the wavelength λ of the signal to be transmitted/received in the substrate on which the phase shifter 40 is mounted. The material of the second additional bypass line A_{b} is not limited as long as it has electrical conductivity.

The switch group includes eight switches S₁. The switch group includes seven switches S₂ and seven switches S₃. The switch group includes eight switches S₄, eight switches S₅, and eight switches S₆. The switch group includes four first additional switches (Sₐ₁, Sₐ₂, Sₐ₃, Sₐ₄) and four second additional switches (S_{b1}, S_{b2}, S_{b3}, S_{b4}). The closely disposed switches may be configured as a single switch. The structure and the material of the switch included in the switch group are not limited as long as the switch can be used as a microwave switch. For example, the switch may include a MEMS, a PIN diode, an FET, or the like. For example, a switch made of a material such as gallium nitride or gallium oxide can be used. For example, the switch may include a switching element including a thin film of vanadium dioxide VO₂.

The switch S₁ is disposed at the first end of the first radial line included in the spoke portion 42. The switch S₁ is used to switch the connection between the hub portion 41 and the first radial line. When the switch S₁ is in the ON state, the hub portion 41 and the first radial line are electrically connected. When the switch S₁ is in the OFF state, the hub portion 41 and the first radial line are not electrically connected.

The switch S₂ is disposed at the second end of the second radial line included in the spoke portion 42. The switch S₂ is used to switch the connection between the second radial line and the arcuate line. When the switch S₂ is in the ON state, the second radial line and the arcuate line are electrically connected. When the switch S₂ is in the OFF state, the second radial line and the arcuate line are not electrically connected.

The switch S₃ is disposed at the end of the arcuate line included in the rim portion 43. The switch S₃ is used to switch connection between two adjacent arcuate lines. When the switch S₃ is in the ON state, the two adjacent arcuate lines are electrically connected via the switch S₃. When the switch S₃ is in the OFF state, the two arcuate lines adjacent to each other via the switch S₃ are not electrically connected.

The switch S₄ is disposed at the second end of the first radial line. The switch S₅ is disposed at the end of the bypass line. The switch S₆ is disposed at the first end of the second radial line. The switch S₄, the switch S₅, and the switch S₆ are used for switching connection of the first radial line, the second radial line, and the bypass line. When the switch S₄ and the switch S₅ are in the ON state and the switch S₆ is in the OFF state, the first radial line and the bypass line are electrically connected. When the switch S₄ is in the OFF state and the switches S₅ and S₆ are in the ON state, the bypass line and the second radial line are electrically connected. When the switch S₄ and the switch S₆ are in the ON state and the switch S₅ is in the OFF state, the first radial line and the second radial line are electrically connected. In a normal use situation, not all of the switch S₄, the switch S₅, and the switch S₆ are set to the ON state.

The first additional switch Sai is disposed at the first end of the first additional bypass line Aₐ. The first additional switch Sₐ₂ is disposed at the first end of the arcuate line C₀₁. The first additional switch Sₐ₃ is disposed at the second end of the arcuate line C₀₁. The first additional switch Sₐ₄ is disposed at the second end of the first additional bypass line Aₐ. The first additional switch (Sₐ₁, Sₐ₂, Sₐ₃, Sₐ₄) is used for switching between the arcuate line C₀₁ and the first additional bypass line Aₐ. When the first additional switch Sₐ₁ and the first additional switch Sₐ₄ are in the ON state and the first additional switch Sₐ₂ and the first additional switch Sₐ₃ are in the OFF state, the first additional bypass line Aₐ is selected. When the first additional switch Sₐ₁ and the first additional switch Sₐ₄ are in the OFF state and the first additional switch Sₐ₂ and the first additional switch Sₐ₃ are in the ON state, the arcuate line C₀₁ is selected. The line length is longer by λ/32 in a state where the first additional bypass line Aₐ is selected than in a state where the arcuate line C₀₁ is selected. In a normal use situation, not all of the first additional switches (Sₐ₁, Sₐ₂, Sₐ₃, Sₐ₄) are set to the ON state.

The second additional switch S_{b1} is disposed at the first end of the second additional bypass line A_{b}. The second additional switch S_{b2} is disposed at the first end of the arcuate line C₀₂. The second additional switch S_{b3} is disposed at the second end of the arcuate line C₀₂. The second additional switch S_{b4} is disposed at the second end of the second additional bypass line A_{b}. The second additional switch (S_{b1}, S_{b2}, S_{b3}, S_{b4}) is used for switching between the arcuate line C₀₂ and the second additional bypass line A_{b}. When the second additional switch S_{b1} and the second additional switch S_{b4} are in the ON state and the second additional switch S_{b2} and the second additional switch S_{b3} are in the OFF state, the second additional bypass line A_{b} is selected. When the second additional switch S_{b1} and the second additional switch S_{b4} are in the OFF state and the second additional switch S_{b2} and the second additional switch S_{b3} are in the ON state, the arcuate line C₀₂ is selected. The line length is longer by λ/64 in a state where the second additional bypass line A_{b} is selected than in a state where the arcuate line C₀₂ is selected. In a normal use situation, not all of the second additional switches (S_{b1}, S_{b2}, S_{b3}, S_{b4}) are set to the ON state.

In the present example embodiment, the additional bypass line is disposed on the arcuate line of the rim portion 43. In the present example embodiment, the resolution of the phase shifter 40 can be improved according to the line length of the additional bypass line. In the example of FIG. 12, the resolution is improved to λ/64 (about 5.6 degrees) by adding an additional bypass line that can obtain a difference in line length of λ/64. The length and the number of additional bypass lines are not limited to the example of FIG. 12. The resolution of the phase shifter 40 is set according to the difference in line length obtained by adding the additional bypass line.

As described above, the phase shifter according to the present example embodiment includes the hub portion, the spoke portion, the rim portion, the bypass portion, the additional bypass portion, and the switch group. The hub portion is connected to the power-feeding point of the patch antenna. The switch group includes a plurality of switches. The spoke portions are disposed radially centered on the hub portion. The spoke portion includes a plurality of radial lines electrically connected to the hub portion via any of the plurality of switches. The rim portion is disposed along an arc centered on the hub portion. The rim portion includes a plurality of arcuate lines electrically connected to the plurality of radial lines via any of the plurality of switches. The bypass portion includes at least one bypass line that bypasses two adjacent radial lines. The plurality of radial lines includes a first radial line and a second radial line. The first end of the first radial line is electrically connected to the hub portion via any of the plurality of switches. The second end of the first radial line is electrically connected to the end of any bypass line included in the bypass portion and the first end of the second radial line via any of the plurality of switches. The first end of the second radial line is electrically connected to the end of any bypass line included in the bypass portion and the second end of the first radial line via any of the plurality of switches. The second end of the second radial line is electrically connected to the end of any of the arcuate lines included in the rim portion. The additional bypass line is electrically connected to at least one of the plurality of arcuate lines included in the rim portion via any of the plurality of switches.

In the phase shifter of the present example embodiment, an additional bypass line is disposed in the arcuate line. According to the phase shifter of the present example embodiment, the phase of the signal to be transmitted/received is controlled by the difference between the line length of the additional bypass line and the line length of part of the arcuate line in which the additional bypass line is disposed. Therefore, the phase shifter of the present example embodiment can improve the resolution of the phase shift amount of the signal to be transmitted/received, as compared with the phase shifters of the first to third example embodiments.

### Fifth Example Embodiment

Next, a phase shifter according to a fifth example embodiment will be described with reference to the drawings. The phase shifter of the present example embodiment is different from that of the first to fourth example embodiments in that a bypass line is added to a radial line included in a spoke portion. The bypass line added to the radial line included in the spoke portion is also referred to as an additional bypass line. In the present example embodiment, an example in which an additional bypass line is added to the configuration of the first example embodiment will be described. The additional bypass line may be added to the configurations of the second to fourth example embodiments.

### Configuration

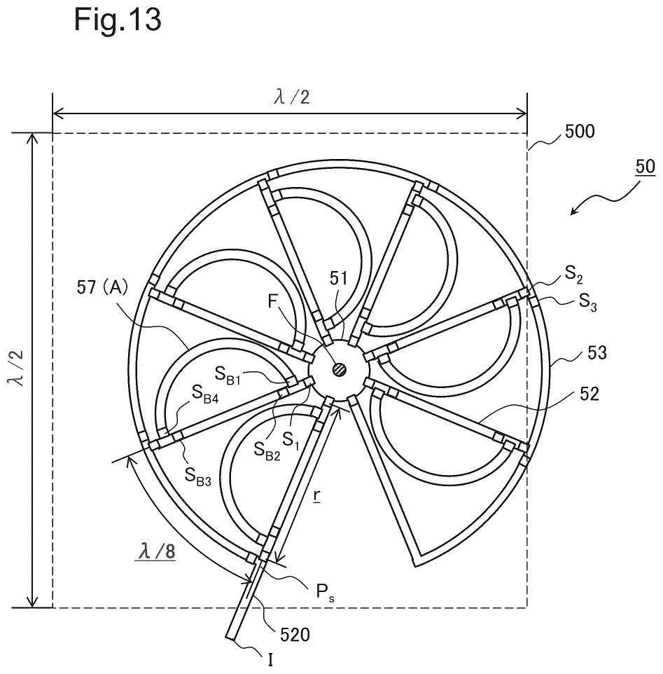

FIG. 13 is a conceptual diagram illustrating an example of a configuration of a phase shifter 50 according to the present example embodiment. The phase shifter 50 has a wheel-shaped outer shape. The phase shifter 50 includes a hub portion 51, a spoke portion 52, a rim portion 53, an additional bypass portion 57, and a switch group. The spoke portion 52 includes a plurality of radial lines. The additional bypass portion 57 includes a plurality of additional bypass lines. The rim portion 53 includes a plurality of arcuate lines. The switch group includes a switch S₁, a switch S₂, a switch S₃, a switch S₄, a switch S₅, and a switch S₆. The switch group includes an additional switch (S_{B1}, S_{B2}, S_{B3}, S_{B4}).

The phase shifter 50 is disposed in association with the patch antennas 500 disposed at the position indicated by the dashed rectangle. The size of the patch antenna 500 is set in accordance with the wavelength λ of the signal to be transmitted/received in the substrate (not illustrated) on which the phase shifter 50 is mounted. The wavelength λ corresponds to a value obtained by dividing the wavelength λ₀ in vacuum by the square root of the relative dielectric constant εᵣ of the substrate. In the example of FIG. 13, the patch antenna 500 is a square having a side length of λ/2. Details of the correspondence relationship between the phase shifter 50 and the patch antenna 500 will be described in the sixth example embodiment to be described later.

The hub portion 51 is a disk-shaped conductor including a center point of the phase shifter 50. The hub portion 51 is electrically connected to the power-feeding point F of the patch antenna 500. The position of the power-feeding point F is a position deviated from the position (center) where the two diagonals of the patch antenna 500 intersect by the characteristic impedance. The hub portion 51 is electrically connected to the plurality of radial lines included in the spoke portion 52 via the switch S₁ and the additional switch S_{B2}. The material of the hub portion 51 is not limited as long as it has electrical conductivity.

The spoke portion 52 includes a plurality of radial lines. In the example of FIG. 13, the spoke portion 52 includes eight radial lines. The first end of the radial line is connected to the additional switch S_{B2}. The radial line is electrically connected to the hub portion 51 via the switch S₁ and the additional switch S_{B2}. The second end of the radial line is connected to the additional switch S_{B3}. The radial line is electrically connected to any of the arcuate lines included in the rim portion 53 via the additional switch S_{B3} and the switch S₂. The material of the radial line is not limited as long as it has electrical conductivity.

The rim portion 53 includes a plurality of arcuate lines. In the example of FIG. 13, the rim portion 53 includes eight arcuate lines. The line length of the arcuate line is set to a length (λ/8) that is ⅛ of the wavelength λ of the signal to be transmitted/received in the substrate on which the phase shifter 50 is mounted. The line length of the arcuate line corresponds to a length obtained by dividing the circumference of a circle centered on the hub portion 51 into eight equal parts.

The first end of the arcuate line included in the rim portion 53 is connected to the switch S₂ and the switch S₃. The arcuate line is electrically connected to any of the radial lines included in the spoke portion 52 via the switch S₂ and the additional switch S_{B3}. The arcuate line is electrically connected to the additional bypass line via the switch S₂ and the additional switch S_{B4}.

Further, the arcuate line is electrically connected to the arcuate line adjacent clockwise via the switch S₃. The second end of the arcuate line is connected to another switch S₂. The second end of the arcuate line is electrically connected to the first end of the arcuate line adjacent counterclockwise via another switch S₂. A lower left arcuate line in FIG. 13 is connected to the switch S₃. The arcuate line is electrically connected to a signal input unit 520 including the start point Pₛ via the switch S₃. The arcuate line and the radial line at the lower right of FIG. 13 are integrated without via the switch S₂. An arcuate line is not disposed between the lower left arcuate line and the lower right arcuate line, and an interval is provided. The material of the rim portion 53 is not limited as long as it has electrical conductivity.

The additional bypass portion 57 includes seven additional bypass lines A. The additional bypass line A is provided in each of the seven radial lines. The additional bypass line A has an arc shape. The additional bypass line A may be disposed at a position other than the position illustrated in FIG. 13. The additional bypass line A has an arc shape. There may be a radial line in which the additional bypass line A is not disposed.

The first end of the additional bypass line A is connected to the additional switch S_{B1}. The additional bypass line A is electrically connected to the hub portion 51 via the additional switch S_{B1} and the switch S₁. The second end of the additional bypass line A is connected to the additional switch S_{B4}. The additional bypass line A is electrically connected to the arcuate line via the additional switch SB₄ and the switch S₂. The difference between the line length of the additional bypass line A and the line length of the arcuate line C₀₁ is set to a length (λ/32) of 1/16 of the wavelength λ of the signal to be transmitted/received in the substrate on which the phase shifter 50 is mounted. The material of the additional bypass line A is not limited as long as it has electrical conductivity.

The switch group includes eight switches S₁. The switch group includes seven switches S₂ and seven switches S₃. The switch group includes seven sets of additional switches (S_{B1}, S_{B2}, S_{B3}, S_{B4}). The closely disposed switches may be configured as a single switch. The structure and the material of the switch included in the switch group are not limited as long as the switch can be used as a microwave switch. For example, the switch may include a MEMS, a PIN diode, an FET, or the like. For example, a switch made of a material such as gallium nitride or gallium oxide can be used. For example, the switch may include a switching element including a thin film of vanadium dioxide VO₂.

The switch S₁ is disposed at a peripheral edge of the hub portion 51. The switch S₁ is used to switch the connection between the hub portion 51 and the radial line and the additional bypass line A. The switch S₂ is disposed at the first end of the arcuate line included in the hub portion 55. The switch S₂ is used to switch the connection between the radial line and the additional bypass line A, and the arcuate line. The additional switch S_{B1} is disposed at the first end of the additional bypass line A. The additional switch SB₂ is disposed at the first end of the radial line. The additional switch S_{B3} is disposed at the second end of the radial line. The additional switch SB₄ is disposed at the second end of the additional bypass line A. The additional switch (S_{B1}, S_{B2}, S_{B3}, S_{B4}) is used for switching between the radial line and the additional bypass line A.

When the switch S₁, the additional switch S_{B1}, the additional switch S_{B4}, and the switch S₂ are in the ON state and the additional switch SB₂ and the additional switch S_{B3} are in the OFF state, the additional bypass line A is selected. When the switch S₁, the additional switch S_{B2}, the additional switch S_{B3}, and the switch S₂ are in the ON state and the additional switch S_{B1} and the additional switch SB₄ are in the OFF state, the radial line is selected. The line length is longer by λ/16 in a state where the additional bypass line A is selected than in a state where the radial line is selected. In a normal usage condition, not all of the additional switches (S_{B1}, S_{B2}, S_{B3}, S_{B4}) are set to the ON state.

The switch S₃ is disposed at the end of the arcuate line included in the rim portion 53. The switch S₃ is used to switch connection between two adjacent arcuate lines. When the switch S₃ is in the ON state, the two adjacent arcuate lines are electrically connected via the switch S₃. When the switch S₃ is in the OFF state, the two arcuate lines adjacent to each other via the switch S₃ are not electrically connected.

In the present example embodiment, an additional bypass line is added to the radial line of the spoke portion 52. In the example of FIG. 13, by adding an additional bypass line that can obtain a difference in line length of λ/16, the phase can be controlled in increments of about 22.5 degrees. The length and the number of additional bypass lines are not limited to the example of FIG. 13. For example, when the additional bypass line of the present example embodiment (FIG. 13) and the additional bypass line of the fourth example embodiment (FIG. 12) are combined, a resolution of 5.6 degrees can be achieved.

As described above, the phase shifter according to the present example embodiment includes the hub portion, the spoke portion, the rim portion, the bypass portion, the additional bypass portion, and the switch group. The hub portion is connected to the power-feeding point of the patch antenna. The switch group includes a plurality of switches. The spoke portions are disposed radially centered on the hub portion. The spoke portion includes a plurality of radial lines electrically connected to the hub portion via any of the plurality of switches. The rim portion is disposed along an arc centered on the hub portion. The rim portion includes a plurality of arcuate lines electrically connected to the plurality of radial lines via any of the plurality of switches. The bypass portion includes at least one bypass line that bypasses two adjacent radial lines. The plurality of radial lines includes a first radial line and a second radial line. The first end of the first radial line is electrically connected to the hub portion via any of the plurality of switches. The second end of the first radial line is electrically connected to the end of any bypass line included in the bypass portion and the first end of the second radial line via any of the plurality of switches. The first end of the second radial line is electrically connected to the end of any bypass line included in the bypass portion and the second end of the first radial line via any of the plurality of switches. The second end of the second radial line is electrically connected to the end of any of the arcuate lines included in the rim portion. The additional bypass line is electrically connected to at least one of the plurality of radial lines included in the spoke portion via any of the plurality of switches.

In the phase shifter of the present example embodiment, an additional bypass line is disposed in the radial line. According to the phase shifter of the present example embodiment, the phase of the signal to be transmitted/received is controlled by the difference between the line length of the additional bypass and the line length of the portion of the radial line in which the additional bypass is disposed. Therefore, the phase shifter of the present example embodiment can improve the resolution of the phase shift amount of the signal to be transmitted/received, as compared with the phase shifters of the first to third example embodiments.

### Sixth Example Embodiment

Next, an antenna device according to a sixth example embodiment will be described with reference to the drawings. The antenna device of the present example embodiment is an antenna device including any of the phase shifters according to the first to fifth example embodiments. In the present example embodiment, an example in which the phase shifter of the first example embodiment is included will be described. In the present example embodiment, an example in which a switching element including a thin film of vanadium dioxide VO₂ is included in a phase shifter will be described. The following configuration is an example, and does not limit the structure of the antenna device on which the phase shifter of the present disclosure is mounted.

### Configuration

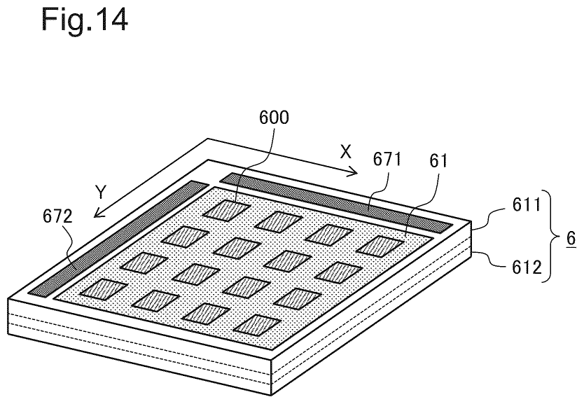

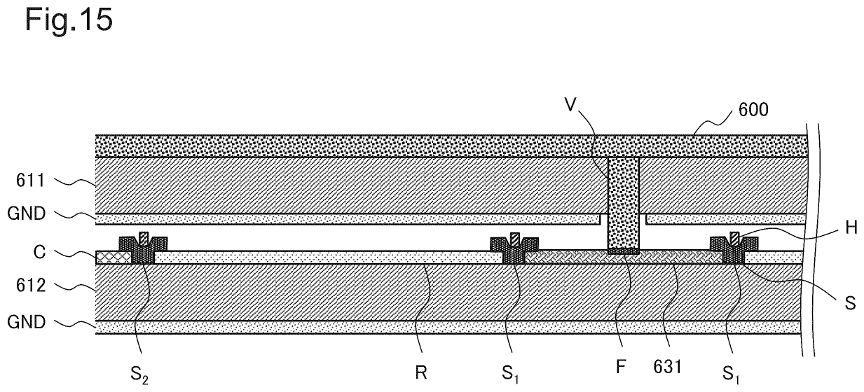

FIG. 14 is a conceptual diagram illustrating an example of a configuration of an antenna device 6 according to the present example embodiment. An example of an external appearance of the antenna device 6 will be described. The antenna device 6 includes a patch antenna array 61 configured by a number of patch antennas 600. FIG. 15 is a partial cross-sectional view illustrating a partial cross section of the antenna device 6. FIG. 15 is a cross-sectional view of the antenna device 6 taken along a radial line of the spoke portion included in the phase shifter. FIG. 15 illustrates a part associated with one of the patch antennas 600 included in the patch antenna array 61. In the present example embodiment, an example in which a switch group is constituted by a switching element including a thin film of vanadium dioxide VO₂ will be described.

The antenna device 6 includes a first substrate 611 and a second substrate 612. The antenna device 6 has a structure in which a first substrate 611 and a second substrate 612 are stacked. A gap is formed between the first substrate 611 and the second substrate 612. A dielectric layer may be sandwiched between the first substrate 611 and the second substrate 612. The patch antenna array 61 is disposed on the upper face of the first substrate 611. The patch antenna array 61 includes the plurality of patch antennas 600. The plurality of patch antennas 600 is disposed in a two-dimensional array. In the example of FIG. 14, the plurality of patch antennas 600 is arrayed along the X direction and the Y direction. The plurality of patch antennas 600 is phased arrayed.

The first substrate 611 includes a transmission face of the radio wave to be transmitted. The patch antenna array 61 is disposed on the upper face (first face) of the first substrate 611. The patch antenna array 61 has a configuration in which the plurality of patch antennas 600 is disposed in a lattice shape. A ground layer (described later) is formed on the second face, of the first substrate 611, facing the first face. For example, the material of the first substrate 611 is a material used for a silicon substrate, glass, or the like. For example, the material of the first substrate 611 may be an insulating film such as an oxide film or a nitride film. The material of the first substrate 611 is not limited as long as the radio wave to be transmitted can be transmitted.

A first drive circuit 671 and a second drive circuit 672 are mounted on the first substrate 611. The first drive circuit 671 is a circuit for performing addressing in the X direction. The second drive circuit 672 is a circuit for performing addressing in the Y direction. The addresses associated with the respective patch antennas 600 can be designated by driving the first drive circuit 671 and the second drive circuit 672. For example, the first drive circuit 671 and the second drive circuit 672 are formed on the surface of the first substrate 611. The first drive circuit 671 and the second drive circuit 672 may be formed inside the first substrate 611.

The second substrate 612 corresponds to a backplane of a liquid crystal display. A phase shifter and a matrix circuit are formed on the upper face of the second substrate 612. The phase shifter has any of the configurations of the first to fifth example embodiments. The matrix circuit has a structure in which a plurality of thin film transistors (TFTs) is disposed in a two-dimensional array. The TFT included in the matrix circuit is formed using a TFT process technology. For example, polysilicon (also referred to as low-temperature polysilicon) manufactured at a low temperature using an excimer laser crystal method or the like can be applied to the TFT. A signal layer is formed above the matrix circuit. The signal layer includes a line included in the phase shifter, a switch group including a plurality of switching elements, a phase shift wiring, a signal line connecting the switch group, and the like. For example, the switching elements are formed using the micro-LED processing technology. For example, the material of the second substrate 612 is silicon or glass. The second substrate 612 may be made of a material other than silicon or glass as long as the radio wave to be transmitted can be transmitted.

A phase shifter is disposed on the upper face of the second substrate 612. The phase shifter is disposed for each patch antenna. A single antenna unit is configured for each patch antenna 600. The function of the phase shifter is expressed for each antenna unit. That is, a phase shift element is configured for each antenna unit. The patch antenna 600 and the phase shifter related to the patch antenna 600 are electrically connected via the via V penetrating the first substrate 611. The via V is made of a conductive material. The upper portion of the via V is connected to the power-feeding point F of the patch antenna 600. The lower portion of the via V is connected to a hub portion 631 of the phase shifter. FIG. 15 illustrates a state in which the first end of the radial line R of the spoke portion and the hub portion 631 are connected via the switch S₁. The second end of the radial line R of the spoke portion is electrically connected to the arcuate line C via the switch S₂.

For example, a plurality of vias penetrating the second substrate 612 may be formed between transmission lines such as radial lines and arc-shaped wires. The plurality of vias penetrate the second substrate 612 from the upper face where the transmission line is formed to the ground layer GLD on the lower face. For example, a conductive portion is formed inside the via and around the opening. For example, conductive plating is applied to the conductive portion of the via. The conductive portion of the via electrically connects the upper face where the transmission line is formed and the ground layer GLD on the lower face. The plurality of vias constitute an electromagnetic interference reduction structure. The electromagnetic interference reduction structure suppresses electromagnetic interference between adjacently disposed transmission lines.

FIG. 15 illustrates a heating wire H used for temperature control of the switches S₁ and S₂. In a case where each of the switch S₁ and the switch S₂ includes a switching element including a thin film of vanadium dioxide VO₂, a change in the resistance value of VO₂ according to a temperature change is used. The electric heating wire H is used to control the resistance value of the thin film of vanadium dioxide VO₂ included in the switch S₁ and the switch S₂. For example, the electric heating wire H is made of an alloy containing nickel Ni or chromium Cr as a main component. The electric heating wire H may be made of an alloy containing chromium Cr, iron Fe, and aluminum Al as main components.

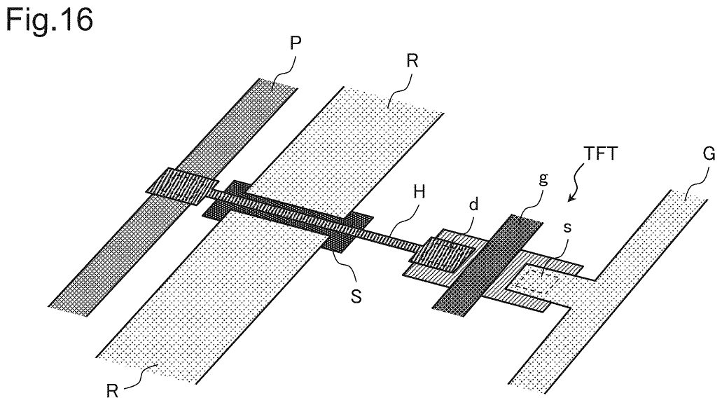

FIG. 16 is a conceptual diagram for describing a configuration example of a switch S configured by a switching element including a thin film of vanadium dioxide VO₂. FIG. 16 illustrates an example in which the switch S made of vanadium dioxide VO₂ is disposed between the radial lines R. The switch S may be disposed at any position exemplified in the first to fifth example embodiments. The two radial lines R are electrically connected via the switch S. The switch S is a switching element including a thin film of vanadium dioxide VO₂. The heating wire H is thermally connected to the switch S. The first end of heating wire H is connected to a power supply line P. The second end of the power supply line P is connected to the drain d of the TFT. The source of the TFT is connected to the ground line G. When a gate voltage is applied to the gate g of the TFT, a current is supplied from the power supply line P between the drain d and the source s of the TFT. The current from the power supply line P is supplied to the TFT via the heating wire H. When the current flows through the heating wire H, the heating wire H generates heat. When the temperature of the switch S in contact with the heating wire H exceeds the phase transition temperature of the vanadium dioxide VO₂, the switch S transitions to the ON state. When the switch S transitions to the ON state, the two radial lines R are electrically connected.

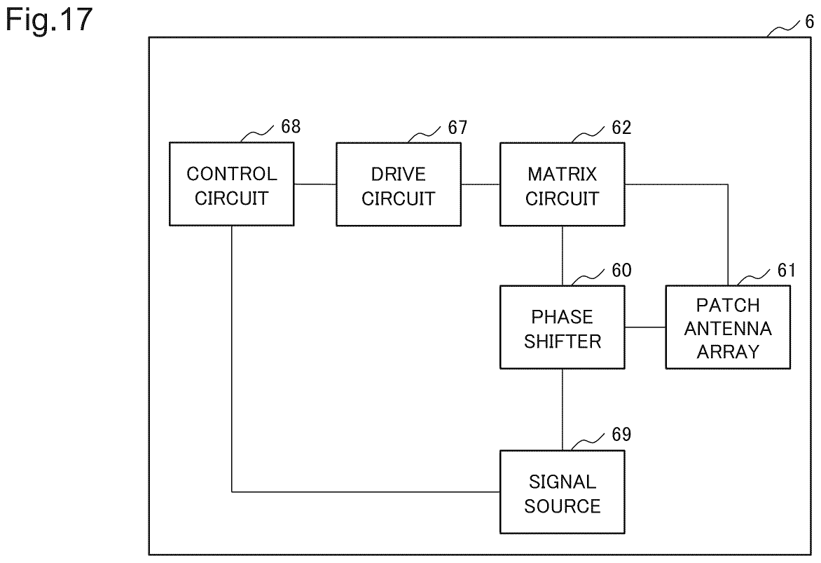

FIG. 17 is a block diagram illustrating an example of a configuration of the antenna device 6. The antenna device 6 includes a patch antenna array 61, a matrix circuit 62, a phase shifter 60, a drive circuit 67, a control circuit 68, and a signal source 69.

The patch antenna 600 is a plate-shaped radiation element. In the present example embodiment, the patch antenna 600 has a square shape. The shape of the patch antenna 600 is not limited to a square shape, and may be a circular shape or other shapes. A slot opening is opened in the ground layer GND below the patch antenna 600. A via V is disposed in the slot opening. The patch antenna 600 is electrically connected to the hub portion 631 of the phase shifter 60 disposed on the upper face of the second substrate 612 via the via V disposed in the slot opening.

The patch antenna 600 is an open type resonator. The patch antenna 600 resonates at a frequency that matches an integral multiple of ½ wavelength of the length of the patch antenna 600. The size of the patch antenna 600 is set according to the wavelength of the radio wave to be transmitted. In order to avoid a decrease in the Q factor due to radio wave radiation and operate the patch antenna 600 as a resonator, a high dielectric layer having a high dielectric constant may be interposed between the first substrate 611 and the second substrate 612. When the high dielectric layer is interposed between the first substrate 611 and the second substrate 612, the thickness of the high dielectric layer and the width of the patch antenna 600 are made sufficiently small with respect to the wavelength of the radio wave to be transmitted.

The matrix circuit 62 has a configuration in which a plurality of thin film transistors (TFT) is disposed in a two-dimensional array. The matrix circuit 62 is formed on the upper face of the second substrate 612 using a TFT process technology. For example, a shield layer (not illustrated) may be formed above the matrix circuit 62. The shield layer is formed to prevent electromagnetic coupling above and below the shield layer. For example, the shield layer includes a conductor. The potential of the shield layer is basically a ground potential. Therefore, a capacitance related to the dielectric constant of the dielectric layer is formed between the transmission line included in the phase shifter 60 and the shield layer. The plurality of TFTs included in the matrix circuit 62 is associated with the plurality of patch antennas 600 included in the patch antenna array 61. For example, the TFT includes a semiconductor layer such as amorphous silicon or polysilicon.

The phase shifter 60 is disposed for each antenna unit. The phase shifter 60 is any of the phase shifters of the first to fifth example embodiments. In the present example embodiment, the phase shifter 60 corresponds to the phase shifter 10 of the first example embodiment.

The drive circuit 67 includes the first drive circuit 671 and the second drive circuit 672. The first drive circuit 671 is a circuit for performing addressing in the X direction. The second drive circuit 672 is a circuit for performing addressing in the Y direction. The drive circuit 67 drives the first drive circuit 671 and the second drive circuit 672 to designate an address associated with each patch antenna 600. The drive circuit 67 drives the plurality of TFTs included in the matrix circuit 62 under the control of the control circuit 68. The drive circuit 67 individually drives the plurality of TFTs disposed in a two-dimensional array.

The control circuit 68 performs control to drive the drive circuit 67 in accordance with a control signal from the outside. The control circuit 68 drives the drive circuit 67 by an active matrix drive system. The control circuit 68 outputs a control signal from the outside to the signal source 69. For example, the control circuit 68 is achieved by a microcomputer or a microcontroller. For example, the control circuit 68 includes a central processing unit (CPU), a random access memory (RAM), a read only memory (ROM), a flash memory, and the like. The control circuit 68 executes control and processing according to a program stored in advance. The control circuit 68 executes control and processing according to a program according to a preset schedule and timing, an external control instruction, and the like.

The signal source 69 is connected to a plurality of switches S constituting a switch group included in the phase shifter 60. The signal source 69 is connected to the control circuit 68. The signal source 69 acquires a control signal from the control circuit 68. The signal source 69 controls ON/OFF of the plurality of switches S constituting the switch group according to the control signal. The signal source 69 may be configured to directly receive a control signal from the outside without going through the control circuit 68.

The signal reaching the signal input unit of the phase shifter 60 through the signal line (not illustrated) connected to the TFT in the ON state is phase-shifted by the line length set in the phase shifter 60 and the phase shift amount related to the dielectric constant of the substrates (the first substrate 611 and the second substrate 612). The phase-shifted signal propagates to the patch antenna 600 via the via V. The signal propagated to the patch antenna 600 is transmitted from the patch antenna 600 as a radio wave to be transmitted. The radio wave transmitted from the patch antenna 600 is based on a signal output from a transmission circuit (not illustrated). The information included in the signal is not particularly limited.

The radio wave received by the patch antenna 600 is received according to the capacitance based on the dielectric constant of the substrate (the first substrate 611 and the second substrate 612) between the patch antenna 600 and the signal line. The received radio wave is phase-shifted by the phase shifter 60. The phase-shifted signal is received by a reception circuit (not illustrated) through a signal line. Information included in the signal received by the reception circuit is decoded by a decoder (not illustrated).

As described above, the antenna device according to the present example embodiment includes the antenna unit including the phase shifter according to each of the first to sixth example embodiments and the patch antenna disposed above the phase shifter. According to the present example embodiment, it is possible to provide an antenna device including a patch antenna having a size related to a wavelength of a signal to be transmitted/received regardless of a polarization state of a radio wave to be transmitted/received.

An antenna device according to an aspect of the present example embodiment includes a patch antenna array in which a plurality of antenna units is disposed in an array. The antenna device of the present aspect includes a patch array antenna configured by a plurality of patch antennas having a size related to a wavelength of a signal to be transmitted/received. According to the antenna device of the present aspect, it is possible to configure a patch array antenna capable of controlling directivity regardless of a polarization state of a radio wave to be transmitted/received.

### Seventh Example Embodiment

Next, a phase shifter according to a seventh example embodiment will be described with reference to the drawings. The phase shifter of the present example embodiment has a simplified configuration of the phase shifter according to each of the first to fifth example embodiments.

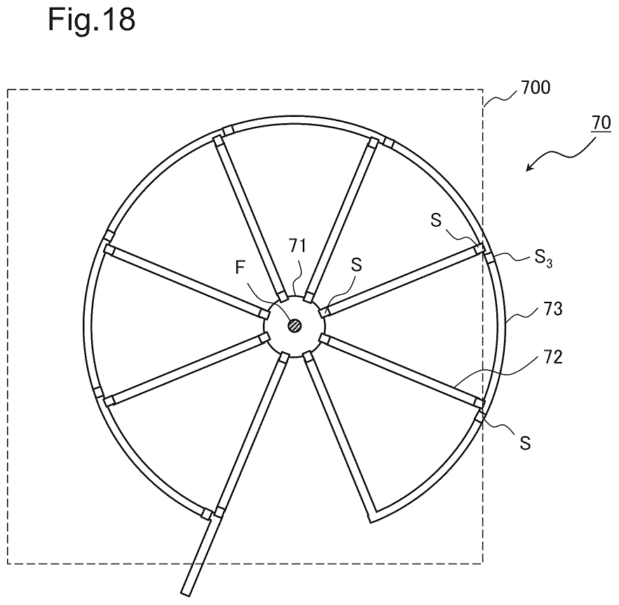

FIG. 18 is a conceptual diagram illustrating an example of a configuration of a phase shifter 70 according to the present example embodiment. The phase shifter 70 includes a hub portion 71, a spoke portion 72, a rim portion 73, and a switch group.

The hub portion 71 is connected to the power-feeding point F of a patch antenna 700. The switch group includes a plurality of switches S. The spoke portions 72 are disposed radially centered on the hub portion 71. The spoke portion 72 includes a plurality of radial lines electrically connected to the hub portion 71 via any of the plurality of switches S. The rim portion 73 is disposed along an arc centered on the hub portion 71. The rim portion 73 includes a plurality of arcuate lines electrically connected to the plurality of radial lines via any of the plurality of switches S.

The phase shifter of the present example embodiment can control the phase shift amount of the radio wave regardless of whether the radio wave to be transmitted/received is a circularly polarized wave or a linearly polarized wave. The phase shifter of the present example embodiment has a circular shape and can be formed compactly. Therefore, the phase shifter of the present example embodiment can be accommodated below the patch antenna. That is, the phase shifter of the present example embodiment can be applied to a patch antenna having a size related to the wavelength of the signal to be transmitted/received regardless of the polarization state of the radio wave to be transmitted/received.

### Hardware

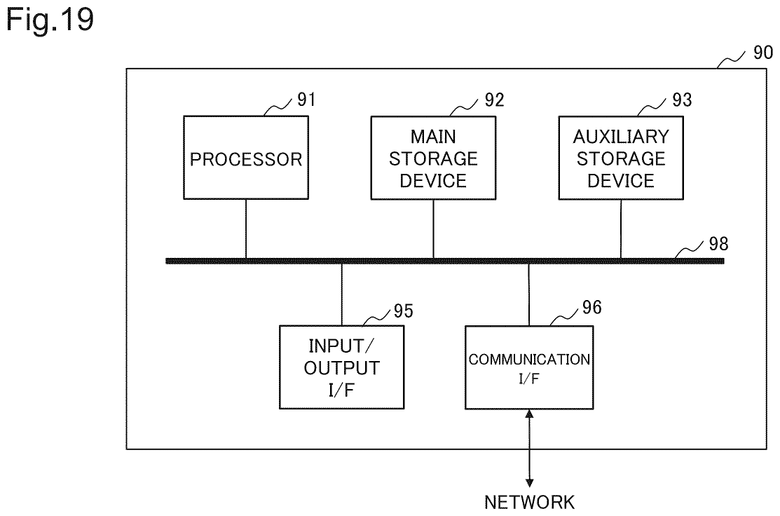

Regarding a hardware configuration that executes control and processing according to each example embodiment of the present disclosure, an information processing device 90 (computer) in FIG. 19 will be described as an example. The information processing device 90 in FIG. 19 is a configuration example for executing control and processing of each example embodiment, and does not limit the scope of the present disclosure.

As illustrated in FIG. 19, the information processing device 90 includes a processor 91, a main storage device 92, an auxiliary storage device 93, an input/output interface 95, and a communication interface 96. In FIG. 19, the interface is abbreviated as an interface (I/F). The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops a program (instruction) stored in the auxiliary storage device 93 or the like in the main storage device 92. For example, the program is a software program for executing control and processing of each example embodiment. The processor 91 executes the program developed in the main storage device 92. The processor 91 executes the program to execute control and process according to each example embodiment.

The main storage device 92 has an area in which a program is developed. A program stored in the auxiliary storage device 93 or the like is developed in the main storage device 92 by the processor 91. The main storage device 92 is achieved by, for example, a volatile memory such as a dynamic random access memory (DRAM). As the main storage device 92, a nonvolatile memory such as a magneto resistive random access memory (MRAM) may be configured/added.

The auxiliary storage device 93 stores various pieces of data such as programs. The auxiliary storage device 93 is achieved by a local disk such as a hard disk or a flash memory. Various pieces of data may be stored in the main storage device 92, and the auxiliary storage device 93 may be omitted.

The input/output interface 95 is an interface that connects the information processing device 90 with a peripheral device based on a standard or a specification. The communication interface 96 is an interface that connects to an external system or a device through a network such as the Internet or an intranet in accordance with a standard or a specification. As an interface connected to an external device, the input/output interface 95 and the communication interface 96 may be shared.

An input equipment such as a keyboard, a mouse, or a touch panel may be connected to the information processing device 90 as necessary. These input devices are used to input of information and settings. In a case where a touch panel is used as the input device, a screen having a touch panel function serves as an interface. The processor 91 and the input device are connected via the input/output interface 95.

The information processing device 90 may be provided with a display device that displays information. In a case where a display device is provided, the information processing device 90 includes a display control device (not illustrated) that controls display of the display device. The information processing device 90 and the display device are connected via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of a hardware configuration for enabling control and process according to each example embodiment of the present invention. The hardware configuration of FIG. 19 is an example of a hardware configuration for executing control and processing according to each example embodiment and does not limit the scope of the present invention. A program for causing a computer to execute control and processing according to each example embodiment is also included in the scope of the present invention.

A program recording medium in which the program according to each example embodiment is recorded is also included in the scope of the present invention. The recording medium can be achieved by, for example, an optical recording medium such as a compact disc (CD) or a digital versatile disc (DVD). The recording medium may be achieved by a semiconductor recording medium such as a Universal Serial Bus (USB) memory or a secure digital (SD) card. The recording medium may be achieved by a magnetic recording medium such as a flexible disk, or another recording medium. In a case where the program executed by the processor is recorded in the recording medium, the recording medium corresponds to a program recording medium.

The components of each example embodiment may be combined in any manner. The components of each example embodiment may be implemented by software. The components of each example embodiment may be implemented by a circuit.

While the present invention is described with reference to example embodiments thereof, the present invention is not limited to these example embodiments. Various modifications that can be understood by those of ordinary skill in the art can be made to the configuration and details of the present invention within the scope of the present invention.

### REFERENCE SIGNS LIST

6 antenna device
10, 20, 30, 40, 50, 60, 70 phase shifter
11, 21, 31, 41, 51, 71 hub portion
12, 22, 32, 42, 52, 72 spoke portion
13, 23, 33, 43, 53, 73 rim portion
35, 45 bypass portion
46, 57 additional bypass portion
61 patch antenna array
62 matrix circuit
67 drive circuit
68 control circuit
69 signal source
100, 200, 300, 400, 500, 600, 700 patch antenna
120, 220, 320, 420, 520 signal input unit
611 first substrate
612 second substrate
631 hub portion
671 first drive circuit
672 second drive circuit

What is claimed is:

1. A phase shifter comprising:
a hub portion that is connected to a power-feeding point of a patch antenna;
a switch group that includes a plurality of switches;
a spoke portion that is disposed radially centered on the hub portion and includes a plurality of radial lines that is electrically connected to the hub portion via any of the plurality of switches; and
a rim portion that is disposed along an arc centered on the hub portion and includes a plurality of arcuate lines that is electrically connected to the plurality of radial lines via any of the plurality of switches.

2. The phase shifter according to claim 1, wherein
the hub portion, the switch group, the spoke portion, and the rim portion are formed on a same substrate,
the spoke portion includes the eight radial lines,
the rim portion includes the seven arcuate lines,
the patch antenna is a square having one side corresponding to a length of ½ of a wavelength of a signal to be transmitted/received in the substrate, and
a line length of each of the plurality of arcuate lines included in the rim portion is ⅛ of a wavelength of the signal to be transmitted/received in the substrate.

3. The phase shifter according to claim 1, further comprising:
a bypass portion including at least one bypass line that bypasses two adjacent radial lines, wherein
the plurality of radial lines
includes a first radial line and a second radial line,
a first end of the first radial line is electrically connected to the hub portion via any of the plurality of switches,
a second end of the first radial line is electrically connected to an end of any of the bypass lines included in the bypass portion and a first end of the second radial line via any of the plurality of switches,
the first end of the second radial line is electrically connected to an end of any of the bypass lines included in the bypass portion and the second end of the first radial line via any of the plurality of switches, and
a second end of the second radial line is electrically connected to an end of any of the arcuate lines included in the rim portion.

4. The phase shifter according to claim 3, wherein
the hub portion, the switch group, the spoke portion, and the rim portion are formed on a same substrate,
the spoke portion includes the eight radial lines,
the rim portion includes the seven arcuate lines,
the patch antenna is a square having one side corresponding to a length of ½ of a wavelength of a signal to be transmitted/received in the substrate,
a line length of each of the plurality of arcuate lines included in the rim portion is ⅛ of a wavelength of the signal to be transmitted/received in the substrate, and
a line length of the bypass line is 1/16 of a wavelength of the signal to be transmitted/received in the substrate.

5. The phase shifter according to claim 1, further comprising:
a bypass portion including at least one first bypass line and at least one second bypass line bypassing two adjacent radial lines, wherein
the first bypass line has a line length longer than a line length of the second bypass line,
the radial line
includes a first radial line, a second radial line, and a third radial line,
a first end of the first radial line is electrically connected to the hub portion via any of the plurality of switches,
a second end of the first radial line is electrically connected to an end of any of the second bypass lines included in the bypass portion and a first end of the second radial line via any of the plurality of switches,
a first end of the second radial line is electrically connected to the end of any of the second bypass lines included in the bypass portion and the second end of the first radial line via any of the plurality of switches,
a second end of the second radial line is electrically connected to an end of any of the first bypass lines included in the bypass portion and a first end of the third radial line via any of the plurality of switches,
the first end of the third radial line is electrically connected to the end of any of the first bypass lines included in the bypass portion and the second end of the second radial line via any of the plurality of switches, and
a second end of the third radial line is electrically connected to an end of any of the arcuate lines included in the rim portion.

6. The phase shifter according to claim 5, wherein
the hub portion, the switch group, the spoke portion, the rim portion are formed on a same substrate,
the spoke portion includes the eight radial lines,
the rim portion includes the seven arcuate lines,
the patch antenna is a square having one side corresponding to a length of ½ of a wavelength of a signal to be transmitted/received in the substrate,
a line length of the arcuate line is ⅛ of a wavelength of the signal to be transmitted/received in the substrate,
a line length of the first bypass line is 1/16 of a wavelength of the signal to be transmitted/received in the substrate, and
a line length of the second bypass line is 1/32 of a wavelength of the signal to be transmitted/received in the substrate.

7. The phase shifter according to claim 1, wherein
at least one additional bypass line electrically connected to at least one of the plurality of arcuate lines and the plurality of radial lines via any of the plurality of switches is disposed.

8. The phase shifter according to claim 1, wherein
each of a plurality of switches included in the switch group is switching elements including a thin film of vanadium dioxide.

9. An antenna device comprising
an antenna unit including:
the phase shifter according to claim 1; and
a patch antenna disposed above the phase shifter.

10. The antenna device according to claim 9, further comprising
a patch antenna array in which a plurality of the antenna units is disposed in an array.
